(19) United States
(12) Patent Application Publication
(10) Pub. No.: US 2013/0080321 A1
(43) Pub. Date: Mar. 28, 2013

(54) Method for Recipient Orientated Financial Services

(71) Applicant: Michael Joseph Mulhall, Ottawa (CA)

(72) Inventor: Michael Joseph Mulhall, Ottawa (CA)

(21) Appl. No.: 13/352,372

(22) Filed: Jan. 18, 2012

Related U.S. Application Data
(60) Provisional application No. 61/537,626, filed on Sep. 22, 2011.

(51) Int. Cl. G06Q 40/00

(52) U.S. Cl. 705/41

(57) ABSTRACT

A method allowing a first person to provide a “virtual” gift to a second party is disclosed, referred to as a “credit gifting” system, wherein the first person accesses an application allowing predetermined aspects of the gift, such as the retailer, store, product type etc to predetermined whilst adding personal messages etc. The second person receives a gift credit towards a purchase redeemable at the defined retailer or store for any wares/services or only those identified by first person. In another embodiment the second person is able to select the retailer or store to redeem from or if unable to redeem themselves allocate a proxy. Accordingly the method overcomes drawbacks of current “captive” gift cards and pre-paid traditional gift cards whilst also offering enhanced registry services, advertising, retailer demographics etc by leveraging the association of a personal electronic device with the recipient of the gift credit.

### FIELD OF THE INVENTION

This invention relates to providing a “credit” for a recipient to purchase a gift, product or service and more specifically to providing the credit electronically with improved demographic acquisition properties.

### BACKGROUND OF THE INVENTION

The giving of a gift using credit for the purchase of a gift by an individual, a family, an organization, a business, or other group is a common everyday occurrence to us. The giftor, the one giving the gift, typically has suffered anxiety or stress associated with selecting and purchasing the appropriate gift for the giftee, the one receiving the gift, such that it is not only personal to the giftee but says something about the giftor, is appropriate, is something they believe the giftee wants and is not going to be disposed off, hidden away or re-gifted to another giftee. The advent of traditional gift cards by stores and other organizations relieved a measure of this stress in that now the giftor relinquished some portions of the gift giving process by allowing the giftee to select the gift they wanted within the value of the gift given or by adding to it to buy something more expensive. However, whilst generally this removed the “unwanted gift” aspect of gift giving it also removed the personal selection of the gift by the giftor for the giftee. It still burdens the giftor with how and where the traditional gift card is purchased, paid for, and sent to the giftee.

The advent of the Internet and electronic commerce on the Internet has not fundamentally changed either the traditional gift giving approach or that based upon traditional gift cards, sometimes called gift certificates. Essentially the Internet allows the giftor to go online, browse a wider selection of stores and products than they would traditionally have been able to physically access and chose a gift for the giftee which is then charged to one of their financial instruments, such as for example their PayPal™ account or a credit card, before being dispatched by the retailer to the giftee perhaps with a simple personal message from the giftor. Similarly with traditional gift cards the Internet has allowed giftors to access a wider range of traditional gift cards and have these delivered to the giftee who then uses them in exactly the same manner, namely physically takes the traditional gift card to the store and redeems it against an item they select. Further, the Internet has opened new channels of business such as Amazon™, iTunes™, etc which have no physical retail outlets and in some instances even no warehousing or distribution infrastructure as everything is outsourced. However, not all stores through factors including but not limited to size, resources, etc are able to issue traditional gift cards.

Accordingly, when considering traditional gift cards these are generally associated with a particular retailer and hence the giftor selects for example a Sears™ gift card, an iTunes™ gift card, an American Eagle™ gift card and that is sent to the giftee. If the giftor purchases the traditional gift card at a store or online and has it mailed to them prior to sending it to the giftee then the only information that the retailer may have is that it was sold to the giftor, and the giftor must still send the traditional gift card to the giftee. In many instances the retailer does not even have any information on the giftee or giftor as unless the giftor or giftee redeems the traditional gift card in conjunction with another financial instrument that provides the retailer with information relating to themselves, such as a bank debit card, a credit card etc, then the retailer has minimal demographic information on the use of their traditional gift cards and does not gain any information allowing them to build a picture of either the giftor or giftee's purchasing habits that they can use in targeted advertising at a subsequent date. Further, whilst a traditional gift card may have been sent to the giftee by the retailer at the request of the giftor without the associated financial instrument outlined above there is nothing to tell the retailer that is was actually used by the giftee.

Retailers have a vested interest in understanding the demographics of their customer base as well as the purchasing habits of customers both as a whole and individually. With the former these demographics provide the overall structure to their product lines, branding, etc whilst the latter allows them to provide targeted advertising or more personal advertising and/or communications. In order to achieve this it would be beneficial to provide a closer association between the activity of purchasing a traditional gift card, the recipient of the traditional gift card and their transactions with that traditional gift card. Additionally hundreds of millions of dollars of traditional gift cards are lost, unclaimed or are rescinded each year, the latter where the expiry date of the traditional gift card has expired before the giftee uses all of the credit resulting in consumer dissatisfaction and even Government intervention and regulations, such as outlined below in respect of United States CARD Act.

Further, the giftor may be resident in another part of the same country as the giftee, resident within another country, or wish to give the giftee a gift that they can utilize in combination with a planned vacation, business trip, etc of the giftee. In such instances the giftor may not be able to establish a retailer to provide the traditional gift card in association with wares or services they would like to give and may resort to sending simply a financial gift, such as money, cheque, travelers cheques etc, and thereby they or the giftee may consider this impersonal. This gift also provides nothing to the benefit of the retailer in improving their demographic or personal information. Additionally such restrictions impact consumers views of so-called “captive” gift cards, i.e. those associated with a single retailer. Such consumer confidence is further compromised by failures of retailers, for example approximately US$100 million in loaded gift card value were compromised when retailers such as Sharper Image™ and Linens 'n Things™ failed in 2008. Legal adjustments in the United States under Title IV of the Credit Card Accountability and Responsibility and Disclosure (CARD) Act to make 5 years the minimum “life” of a traditional gift card are expected to go into force in late 2010 to address consumer complaints and confidence in traditional gift cards, both “captive” and “general purpose”, these later cards being pre-paid debit cards.

Research from financial advisory firm TowerGroup (http://www.towergroup.com/research/news/news.htm?newsId=5500) projected that total gift card market would fall from US$91 billion in 2008 to US$87 billion in 2009, the second straight yearly decline. Store gift card sales, i.e. “captive” or “closed” cards, were projected to fall from US$63 billion to US$58 billion, while “general purpose” or “open” pre-paid gift cards were projected to show a modest 3% increase to US$29 billion from US$28 billion last year. In fact, sales of general purpose, open, prepaid gift cards, such as those offered by Mastercard™ or Visa™, have increased in revenue consistently for the last five years thereby further eroding the personal information that may be acquired and utilized by retailers.

However, the introduction of new distribution channels such as gift card malls are creating opportunities for closed gift card issuers by removing some of the inconvenience of purchasing by centralizing multiple retailers closed cards to one accessible location, e.g. the drug store, grocer, or post office, they must still be bought from a retail location, sent by the purchaser to the recipient, and may be viewed as impersonal by the recipient. Additionally, they are by their very nature closed to a specific retailer or retailers within a single corporate family. Whilst the retailer may have information relating to the giftor, i.e. person buying the traditional gift card if they bought it direct from the retailer rather than through a “gift card mall”, they will have no information on the giftee, i.e. the person receiving the traditional gift card, unless they whilst redeeming the value of the traditional gift card provide information relating to themselves such as through using a financial instrument to increase the value of the purchase or make additional purchases.

In contrast, open cards are not limited to the retailer and whilst the retailer where the open card is used may have information relating to the giftee they will have no information relating to the giftor. That information will reside with the provider of the open card, such as an open card provider directly, i.e. MasterCard, Visa, Capital One etc, or the retailer wherein the giftor purchases the open card for the giftee, i.e. Western Union.

This customer information is important to retailers to establish demographics and trends for product offerings as well as allowing them to leverage this customer information to provide demographically or customer specific product information or special offers.

According to embodiments of the invention an online business that allows the giftor to personalize the virtual gift, the gift credit, and provides them with the flexibility to select across the spectrum from open loop to closed loop. The invention allows the giftor to select a particular gift or gift type for redemption either open loop with any participating retailer to the system or closed loop with a specific retailer or retailer grouping they chose. The system according to embodiments of the invention allows global virtual gifting and redemption.

A closed loop traditional gift card does not provide the giftee with an ability to receive a traditional gift card and subsequently allows them to change the retailer to which the gift credit relates. Whilst an open loop traditional gift card provides this flexibility the costs associated with accepting the open loop card may mean that a specialist retailer may not accept that open loop card. Accordingly it would be beneficial to provide the giftee with the means wherein if the gift credit has been associated with a particular store of a retailer to change the store for example from a local store to another perhaps specialist store that the giftee is willing to visit to acquire the item they wish to purchase.

It would be further beneficial if the gift credit was provided in an electronic format rather than a physical format. Accordingly, linking the gift credit to a portable electronic device of the giftee for example allows the gift credit to be provided in a redeemable format, i.e. a 2D bar code, as well as allowing retailers and others associated with retailing opportunities the ability to target the giftee specifically.

Accordingly it is an intention of embodiments of the invention to provide an increased level of personal association of a gift credit between a giftor and giftee whilst also providing retailers with increased demographic and customer specific information, addressing drawbacks of current closed and open traditional gift cards. In order to differentiate the invention and embodiments of the invention from such “captive” or closed traditional gift cards, open traditional gift cards as well as debit cards, credit cards etc we refer to the approach as “credit gifting” throughout this application and to a “gift credit” as the specific virtual gift card provided by the giftor to the giftee.

### SUMMARY OF THE INVENTION

It is an object of the present invention to obviate or mitigate at least one disadvantage of the prior art.

In accordance with an embodiment of the invention there is provided a method comprising:
storing in a non-transitory tangible computer readable medium of a first computer system connected to a first network data a software application encoding a computer process for execution by a processor of a portable electronic device, the computer process comprising:
   receiving from a second computer system a first electronic message to the portable electronic device associated with a first user first data comprising a first data portion relating to an aspect of a second user, a second data portion relating to a first financial transaction executed by the second user on a second computer system providing a credit for the first user, and a third data portion relating to a unique first user credential to access the computer system;
   transmitting from the portable electronic to the second computer system a second electronic message, the second electronic message being generated in dependence upon at least the unique first user credential;
   receiving from the second system a second electronic message comprising a fourth data portion relating to the credit for the first user; and
   displaying to the first user in dependence upon an aspect of the portable electronic device information derived from the fourth data portion in relation to the credit.

In accordance with an embodiment of the invention there are provided one or more non-transitory tangible computer readable media encoding a computer process for execution by a processor of a portable electronic device, the computer process comprising:
receiving from a first computer system a first electronic message to the portable electronic device associated with a first user first data comprising a first data portion relating to an aspect of a second user, a second data portion relating to a first financial transaction executed by the second user on a second computer system providing a credit for the first user, and a third data portion relating to a unique first user credential to access the computer system;
transmitting from the portable electronic to the first computer system a second electronic message, the second electronic message being generated in dependence upon at least the unique first user credential;
receiving from the first system a second electronic message comprising a fourth data portion relating to the credit for the first user; and
displaying to the first user in dependence upon an aspect of the portable electronic device information derived from the fourth data portion in relation to the credit.

In accordance with an embodiment of the invention there is provided a device comprising a microprocessor, and one or more non-transitory tangible computer readable media encoding a computer process for execution by the processor of a portable electronic device, the computer process comprising:
receiving from a first computer system a first electronic message to the portable electronic device associated with a first user first data comprising a first data portion relating to an aspect of a second user, a second data portion relating to a first financial transaction executed by the second user on a second computer system providing a credit for the first user, and a third data portion relating to a unique first user credential to access the computer system;
transmitting from the portable electronic to the first computer system a second electronic message, the second electronic message being generated in dependence upon at least the unique first user credential;
receiving from the first system a second electronic message comprising a fourth data portion relating to the credit for the first user; and
displaying to the first user in dependence upon an aspect of the portable electronic device information derived from the fourth data portion in relation to the credit.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic of a method of giving a gift card according to the prior art;

FIG. 2 is a schematic of a method of giving a gift card with an Internet based activity by the giftor according to the prior art;

FIG. 3 is a schematic of credit gifting according to an embodiment of the invention wherein the credit gifting system advises the giftee and retailer of the gift credit;

FIG. 4 is a schematic of credit gifting according to an embodiment of the invention wherein the retailer advises the giftee of the gift credit based upon information provided by the credit gifting system;

FIG. 5 is a schematic of credit gifting according to an embodiment of the invention wherein the giftee is advised of the gift credit based upon information provided by the credit gifting system and can select the store from which to redeem the gift credit;

FIG. 6 is a schematic of credit gifting according to an embodiment of the invention wherein the giftee is advised of the gift credit based upon information provided by the credit gifting system and can select both the retailer and the store from which to redeem the gift credit;

FIG. 7 depicts a flow diagram according to an embodiment of the invention;

FIG. 8 is schematic of credit gifting according to an embodiment of the invention wherein the giftee elects a third party to redeem it; and

FIG. 9 shows display screens of a credit gifting application according to an embodiment of the invention wherein a giftor establishes a user profile and a giftee profile;

FIG. 10A shows display screens of a credit gifting application according to an embodiment of the invention wherein a giftor establishes and confirms a gift credit to a giftee;

FIG. 10B shows a display screen of a gift crediting application according to an embodiment of the invention wherein a giftor establishes a product filtering based upon the catalogs of retailers that are members of the credit gifting system;

FIG. 11 shows display screens of a credit gifting application according to an embodiment of the invention presenting translation options relating to the giftor and giftee;

FIG. 12 shows display screens of a credit gifting application according to embodiments of the invention in respect of notifying a giftee of a gift credit;

FIG. 13 shows a system schematic relating to a credit gifting application according to an embodiment of the invention;

FIG. 14 shows display screens of a credit gifting application according to an embodiment of the invention relating to a giftee redeeming a gift credit;

FIG. 15A through 15C show display screens when a giftee accesses a website of a member retailer to gift crediting application according to an embodiment of the invention;

FIG. 16 shows display screens of a credit gifting application according to an embodiment of the invention wherein a giftee is provided incentives from retailing organizations that are members of the gift crediting application;

FIG. 17 depicts a flow diagram according to an embodiment of the invention;

FIG. 18 depicts exemplary display screens of a gift crediting application according to an embodiment of the invention; and

FIG. 19 depicts an exemplary financial system supporting mobile transactions for a gift crediting application according to an embodiment of the invention.

### DETAILED DESCRIPTION

The present invention is directed to providing an increased level of personal association of a gift card exchanged between a giftor and giftee whilst also providing retailers with increased demographic and customer specific information and address drawbacks of prior art approaches. Accordingly it is an object of the invention to provide a more convenient way for a giftor to provide a giftee a credit for a gift in lieu of the gift itself, and which provides additional advantage to giftor, giftee, and retailers.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements. Within these embodiments reference will be made to terms which are indented to simplify the descriptions, including for example giftor relating to the person making the gift, giftee relating to the person receiving the gift, gift credit relating to a credit provided by the giftor to the giftee which can be redeemed by the giftee from a retailer.

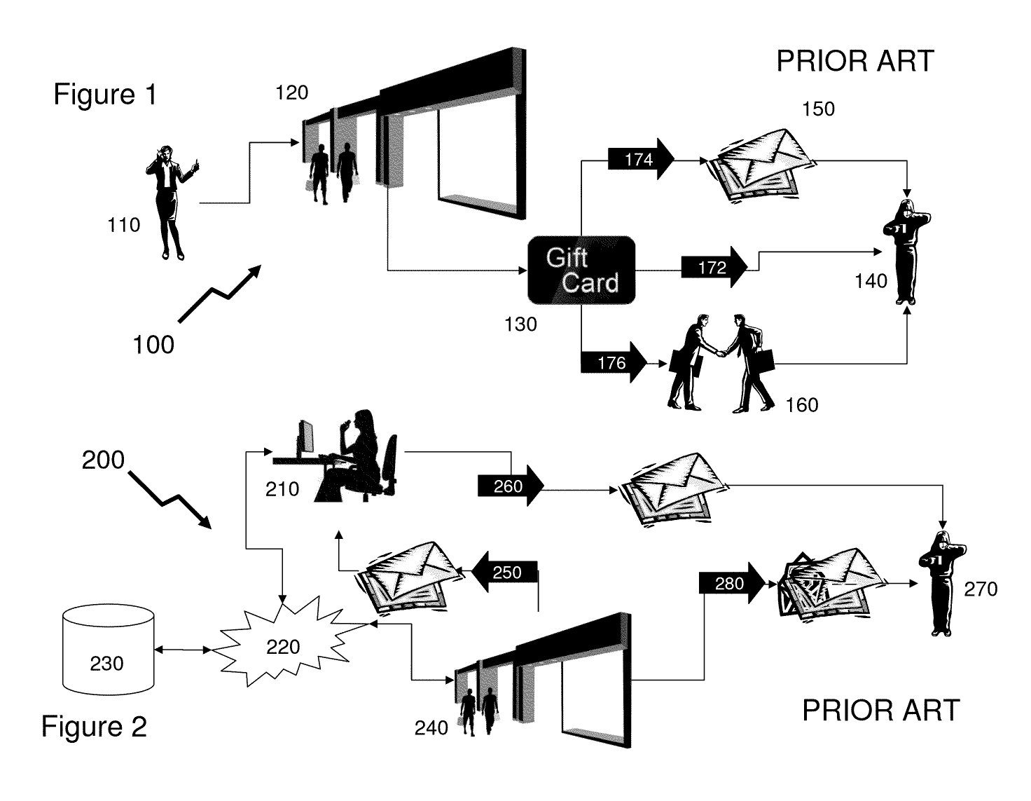

Referring to FIG. 1 there is depicted a schematic 100 of a method of giving a gift card according to the prior art. As shown a giftor 110 wishes to purchase a gift card for giftee 140. As such the giftor 110 visits the retailer 120 that they have chosen to purchase a gift card from and purchases the gift card, not shown for clarity, and departs with gift card 130. They are then presented with the problem of delivering the gift card 130 to the giftee 140. If they live locally to the giftee 140 or are meeting them at a convenient point in time in the future then they may deliver the gift card 130 personally in first process 172. Alternatively they may decide to give it to another individual, for example another family member or friend, to give to the giftee 140 in their behalf in second process 176. If neither of these options is feasible then the giftor 110 would mail the gift card 130 to the giftee 140 in third process 174.

It would be evident that the retailer 120 has little information relating to the gift card 130 unless the giftor 110 uses a credit card or other financial instrument providing their identity or giftee 140 in using the gift card 130 similarly uses a financial instrument providing their identity. Without this information the retailer simply knows that a gift card 130 was bought by a first individual and redeemed at some later point in time by the same or another individual at the same or other retail establishment for specific goods. They cannot assign any demographic information or customer specific information to the purchase or purchases made with the gift card 130.

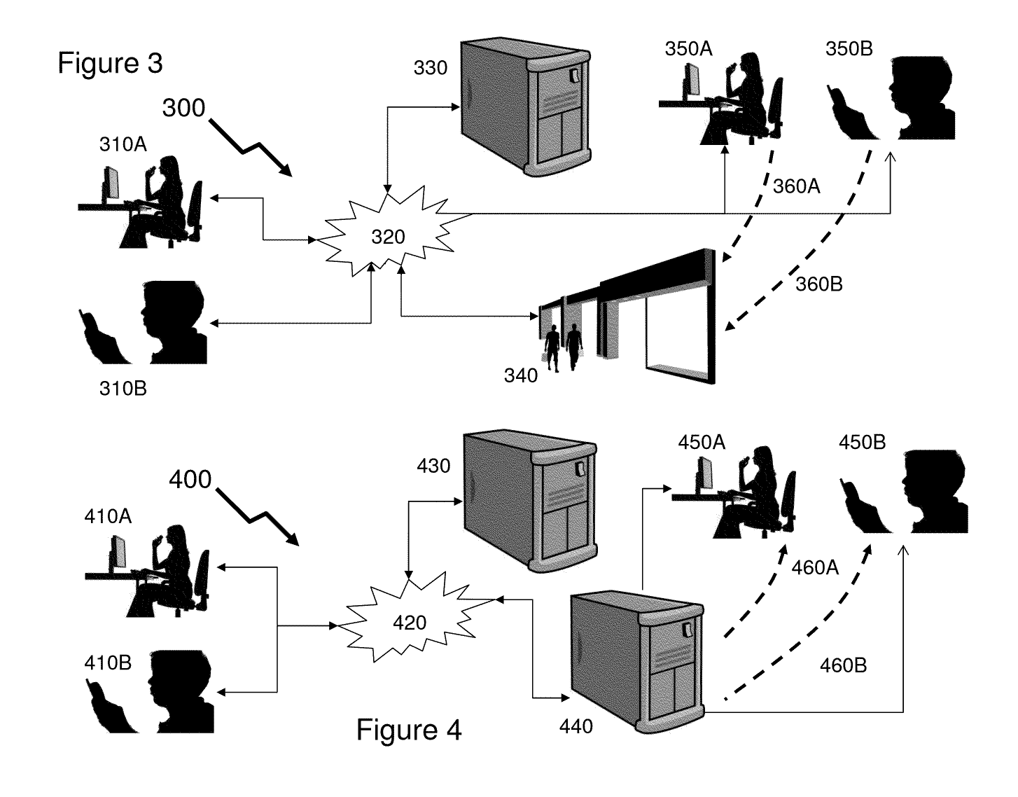

Now referring to FIG. 2 there is depicted a schematic 200 of a method of giving a gift card according to the prior art wherein the giftor 210 is for example unable to get to the retailer 240 or wishes to purchase the gift card, not shown, outside of retailer opening hours. As shown the giftor 210 wishes to purchase a gift card for giftee 270. As such the giftor 210 visits the website of the retailer 240 by accessing the company website server 230 though a computer network 220 such as the Internet. When they have chosen to purchase a gift card from the retailer 240 they enter some personal details in respect of themselves, provide a financial payment and select a delivery address for the gift card. Accordingly the retailer 240 either sends the gift card in first process 250 to the giftor 210 who then mails it in second process 260 to giftee 270, or mails the gift card directly to the giftee 270 in third process 280.

It would be evident that the retailer 240 now has some additional information relating to the gift card as the giftor 210 used a credit card or other financial instrument providing their identity to make the purchase. If the giftor 210 elected to have the gift card delivered directly to the giftee 270 then the retailer now knows a name and address to which the gift card was delivered. However, if the giftor 210 elects to have the gift card delivered to them and then sends it or gives it to the giftee 270 then unless the giftee 270 uses a financial instrument providing their identity to augment their purchase the retailer has little information on the actual correlation between the gift card and giftee 270. They therefore cannot assign significant demographic information or customer specific information to the purchase or purchases made with the gift card.

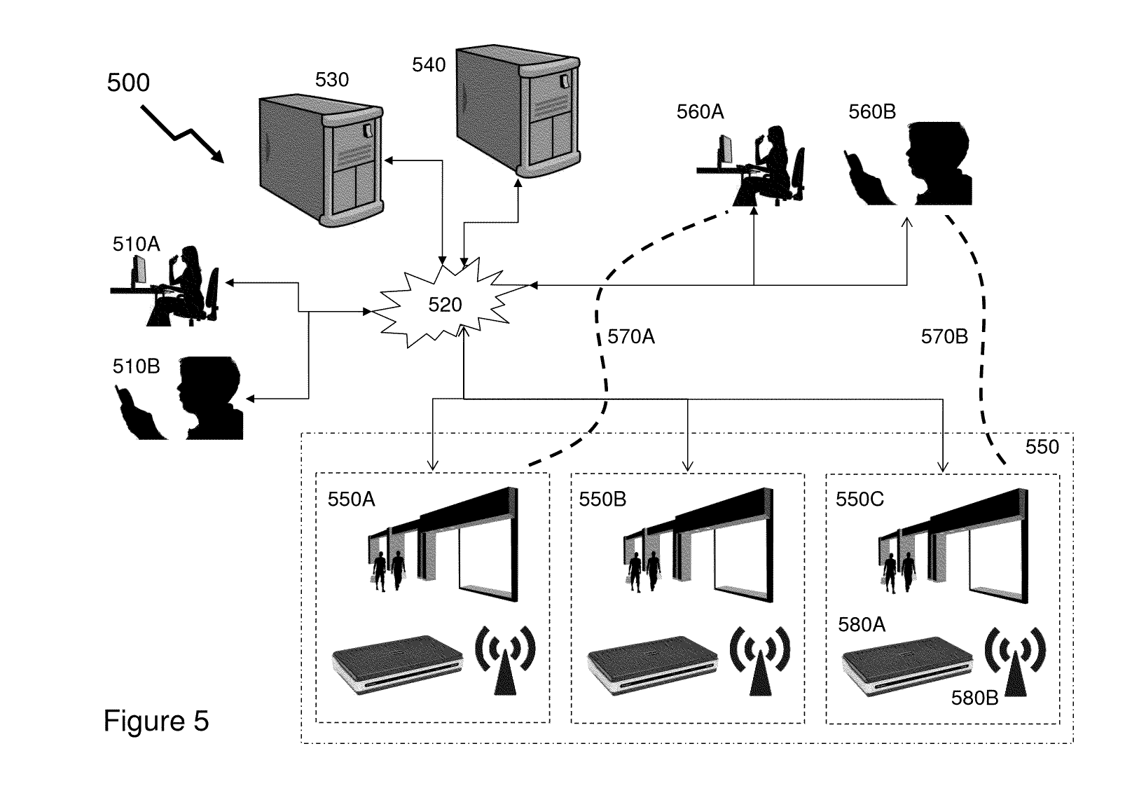

Referring to FIG. 3 there is depicted a schematic 300 of a credit gifting method according to an embodiment of the invention wherein a credit gifting system 330 advises first and second giftees 350A and 350B respectively in conjunction with a retailer 340 of the existence of gift credits purchased. Accordingly as shown a first giftor 310A accesses the credit gifting system 330 through a computer network 320, such as the Internet, from a computer such as, for example, their home computer or work computer. In doing so they are presented with a series of display screens that prompt for, and request, information relating to the gift credit they wish to purchase. These may be contained within a single web page or a plurality of web pages as would be evident to one skilled in the art and may vary according to whether the first giftor 310A is a member of the gift credit system for example, wishes to simply make a purchase as a “guest”, or register and make a purchase. Accordingly the first giftor 310A provides information relating to themselves including for example their name, address, age, credit card information or other information relating to a means of paying for the gift credit, i.e. a PayPal™ account and password. At this point the credit gifting system 330 also seeks authorization from the first giftor 310A in respect of using the financial instrument, i.e. credit card, PayPal™ etc. This authorization also includes approval to purchase the gift credit in whatever currency the gift credit is purchased in. Information employed may be associated with a user profile created by the giftor at that point in time or previously.

First giftor 310A is then presented with a series of display screens that allow them to navigate a selection process for selecting the gift credit they wish to send. This will, for example, present a list of member retailers who are part of credit gifting system, which may be selected and refined via one of many methods known to those skilled in the art, for example by selecting a geographic location (e.g. Tampa Bay, Washington, Ottawa, Paris, Berlin etc), an area of interest (i.e. hockey, NASCAR, clothing etc), a list of retailers the first giftor 310A has previously used or prefers, and a list of retailers the recipient, second giftee 350B. Having worked through the selection process the first giftor 310A has now selected a retailer and a store 340 associated with the retailer which meets a predetermined condition in respect of the second giftee 350B to whom they wish to send the gift credit. For example the store 340 may be close to the home or office of second giftee 350B, be specific in choice of goods and services to meet an interest of second giftee 350B, be associated with a location second giftee 350B will be in at a subsequent point in time such as traveling for pleasure or on business.

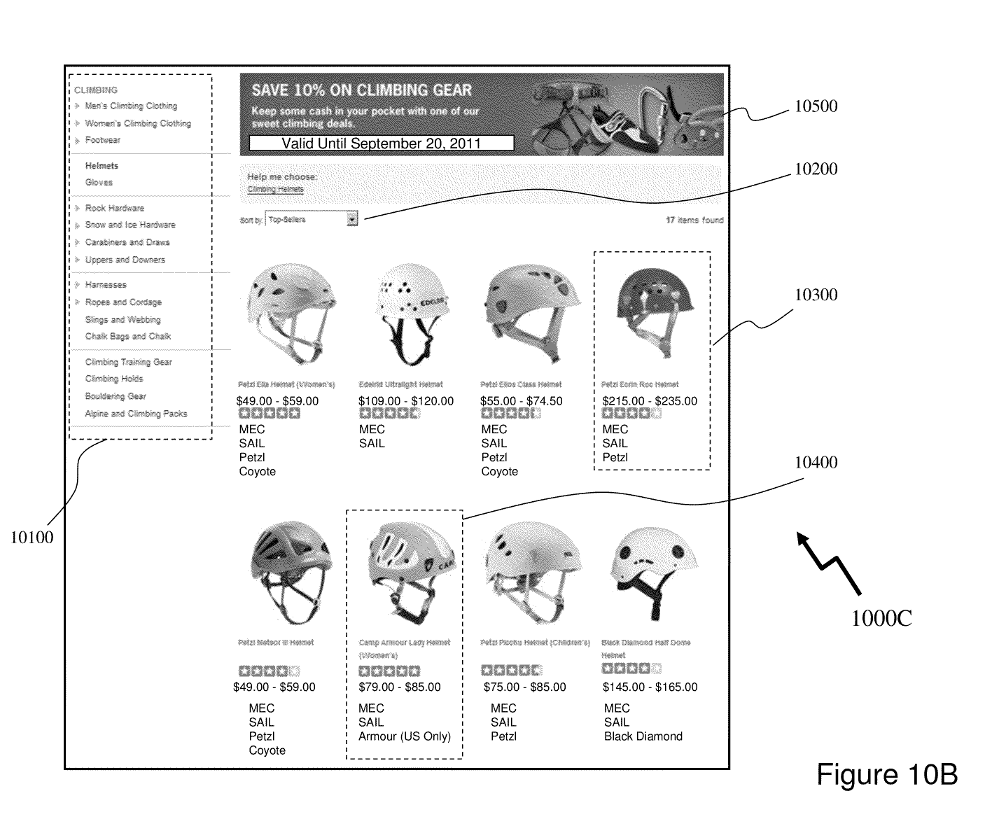

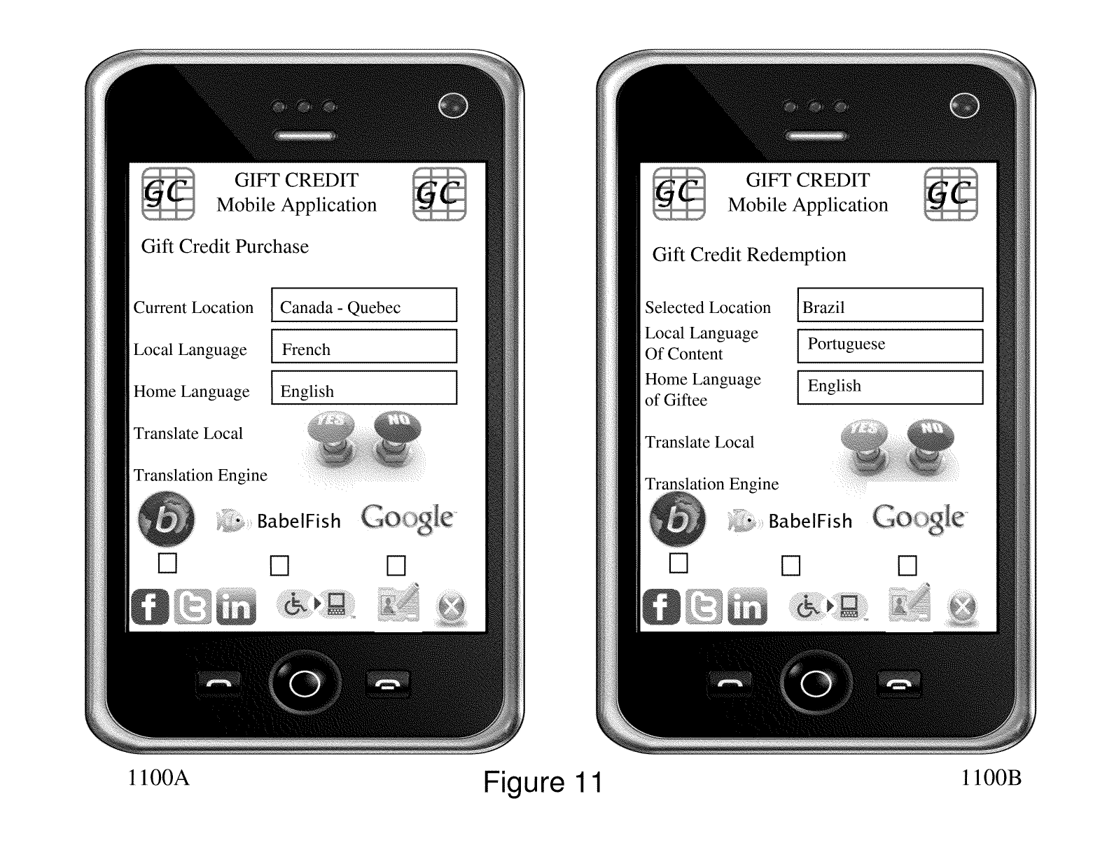

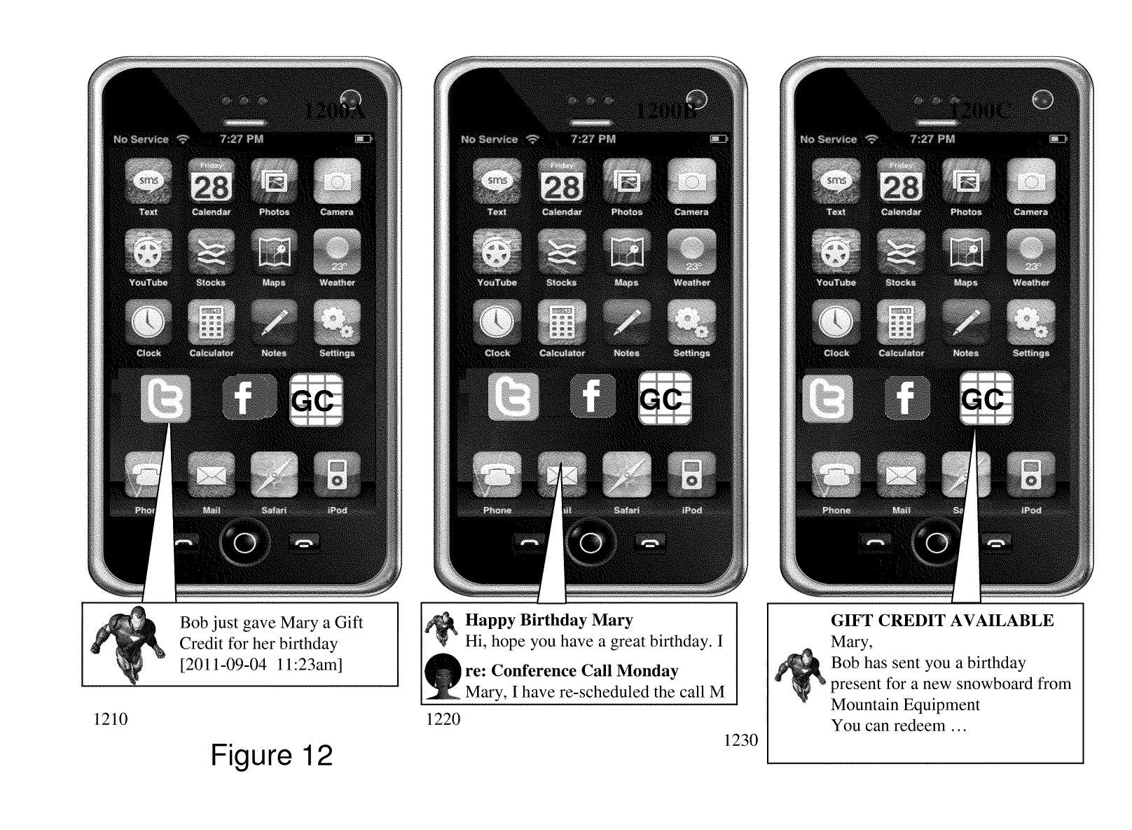

The first giftor 310A then enters information relating to the second giftee 350B such as a name, electronic mailing address and other details they wish to provide or are required in order for the gift crediting system 330 to execute the transaction. It would be evident for example that the first giftor 310A may have to provide some information as a default requirement whilst other information is optional and the first giftor 310A is told that this allows the credit gifting system 330 to subsequently provide other options to the first giftor 310A when they select a gift credit another time or send special offers to the second giftee 350B. Such information as will be seen from descriptions below in respect of FIGS. 9 and 10 for example may be social network information allowing the gift crediting system 330 to retrieve personal preferences of the second giftee 350B. It would be evident to one skilled in the art that this sequence may be modified such that for example the first giftor 350A enters such social network information etc prior to the selection of the retailer etc, and that other variations in the sequence may be provided without departing from the scope of the invention.

Once completed the credit gifting system 330 sends an electronic message to second giftee 350B notifying them that first giftor 310A has purchased them a gift credit at retailer 340 that they may redeem and thereby collect the “gift”. Second giftee 350B receives the notification on their personal electronic device. Subsequently the second giftee 350B goes to retailer 340 in process 360B and redeems the gift credit with methods that include, but not limited to, receiving a credit certificate from the customer service counter on providing valid confirmatory identification, printing a gift certificate at a computer, presenting a 2D barcode at the checkout, or simply going to pay with a financial instrument wherein the retailer computer systems recognize the second giftee 350B and the existing gift credit and hence debit the gift credit against the purchase automatically. Where second giftee 350B exploits a near field communication point-of-sale system (NFCPOS) with their portable electronic device it would be evident that the entire process may be automatically processed based upon the user simply approving a purchase.

Similarly, second giftor 310B accesses the gift crediting system 330 in order to purchase a gift credit for first giftee 350A. As second giftor 310B accesses the gift crediting system 330 from their portable electronic device then they either access a mobile compatible web site, which may or may not be the same web site as accessed by first giftor 310A who accesses from a computer, or using a gift crediting application that they have downloaded to their portable electronic device from either the gift crediting system 330 or an application website, such as for example those operated by portable electronic device provides such as Blackberry™, Apple™ and Nokia™. Second giftor 310B performs the same series of steps such as described above in respect of first giftor 310A in order to select and purchase a gift credit for first giftee 350A. The gift crediting system 330 then sends notification to first giftee 350A that they have received the gift credit from second giftor 350B. Within this embodiment first giftee 350A is not as comfortable with wireless electronic devices or using them for financial transactions through NFCPOS for example. Accordingly the gift crediting system 330 may mail a traditional gift card to the first giftee 350A on behalf of second giftor 310B if that option was selected by the second giftor 310B or may be electronically provided

The first giftee 350A then goes to retailer 340 in process 360A and redeems the gift credit which in the instance it was mailed to them is by presenting the traditional gift card at the checkout. Where the gift credit was electronically provided to them then they may redeem it with methods that include, but not limited to, receiving a credit certificate from the customer service counter on providing valid confirmatory identification, printing a gift certificate on their computer, and printing a gift certificate including a 2D barcode they can present at the checkout.

Where either of the first and second giftees 350A and 350B elects to redeem the gift credit at the customer service count for example then this may, for example, be in the form determined by the retailer such as presenting them with a traditional “captive” gift card or another instrument that they wish to employ. In each notification provided by gift crediting system 330 then to increase the first and second giftees 350A and 350B view of the process overall the gift credit may be provided in a manner personalized to them. For example the gift credit notification, gift certificate printed, or traditional gift card provided by retailer may include “Dear Fred, Knowing your love of rock climbing thought you'd find something here at Mountain Equipment, Love Jane”, wherein “Fred” is associated with second giftee 350B, “Jane” with the first giftor 310A and “Mountain Equipment” with retailer 340. Alternatively, the gift credit may be very specific such as “Dear Sarah, Knowing your love of rock climbing and that it is your birthday I thought you'd like a Petzl Meteor III helmet from SAIL, Love Robert.” wherein “Sarah” is associated with first giftee 350A, “Robert” with the second giftor 310B and “SAIL” with retailer 340. Second giftor 310B also associating the gift credit to a birthday of first giftee 350A during their purchase process on the gift crediting system.

The options relating to redemption of a gift credit are determined in part by the technical capabilities of the retailer 340 and the giftees comfort/acceptance/access to portable electronic devices, NFCPOS, etc. Accordingly, the gift credit system 330 may provide the giftee, for example second giftee 350B, with different redemption options than those provided to first giftee 350A based upon information entered by the giftor or derived by the gift credit system in dependence upon multiple factors, including but not limited to, which retailer(s) the gift credit relates to or which computer system the gift credit notification is accessed upon. Hence, as described above second giftee 350B may be provided with an electronic bar code or any other type of secure recognition that is scanned at or communicated to the point-of-sale that debits the value of the purchase from the gift credited to them. Alternatively, the credit gifting system 330 provides only a message to the second giftee 350B, such as “Dear Fred, Knowing your love of rock climbing there is a credit available for you at Mountain Equipment Co-Op for a Petzl Meteor III helmet, your password to redeem this is Yo Freddie, Love Jane.” Evident to one skilled in the art is that the password may be selected by the giftee for the giftor or established alternatively by the retailer 340/credit gifting system 330 and communicated to the giftee.

It would evident to one skilled in the art that the credit gifting system 330 within this embodiment is able to provide demographic information to the retailer 340 that associates particular products and services to the second giftee 350B but also the association of the giftor to the giftee and the specificity of the gift credit purchased. For example, in the gift credit example between second giftor 310B and first giftee 350A the retailer 340 now knows that “Robert” bought “Sarah” a “Petzl helmet” for her birthday. This allows the retailer to use this information in its planning as well as leveraging this in respect of more specifically targeted advertising, such as for example “Hi Robert, last month you bought a Petzl helmet for Sarah from us here at SAIL. Christmas is coming and this month we have a special on Petzl equipment.” Within the foregoing description of a credit gifting method according to an embodiment of the invention as depicted by schematic 300 it would be apparent to one skilled in the art that in each communication described or implicitly required to perform an action that additional communications between credit gifting system 330, retailer 340, first and second giftors 310A and 310B respectively, and first and second giftees 350A and 350B respectively may be provided, including but not limited, to a receipt indicating the purchase of the gift credit, confirmation of credit from retailer to credit gifting system, and a confirmation receipt from credit gifting system to a giftor when giftee redeems the gift credit.

Within the embodiment described above in respect of FIG. 3 the gift credit has been described as relating to a specific retailer. However, the gift credit system allows the giftor to select as broadly or narrow as they wish and to make the gift credit relate to either a specific retailer or subset of retailers or a specific product or a subset of products. For example, the giftor may elect to allow the giftee to redeem the gift credit with “Champs Sports” at the Mall of America in Bloomington, Minn.; at any retailer within the Mall of America; at any retailer in Bloomington, Minn.; or at any retailer in Minneapolis—St Paul, Minn.; or any retailer in Minnesota and hence increasing geographic coverage. Alternatively, the gift credit could be specified for a “Petzl” helmet, any “Petzl” product, any climbing product, or any sports product. Hence, would be evident to one skilled in the art that the gift credit may be visualized as providing the giftor with the ability to select with varying specificity an area on a 2D surface wherein retailers represent one axis and products the other axis. Accordingly, the gift credit can function as an open loop traditional gift card, a closed loop traditional gift card, a product specific traditional gift card, etc.

When a giftee receives a gift credit that has broad redeeming characteristics, such as any retailer in Minneapolis—St Paul or for any climbing product in Bloomington, Minn.; then the giftee may access the gift crediting system and establish a list of retailers and their outlets that the gift credit may be redeemed at. Retailers, such as retailer 340, are members of the credit gifting system 330 and have agreed to accept the terms and conditions of the credit gifting system 330. These retailers would be advertised and listed within the credit gifting system 330 allowing the first and second giftors 310A and 310B respectively and first and second giftees 350A and 350B respectively to choose them as the retailer to purchase the gift from within the credit gifting system. Optionally, these retailers may direct those accessing their own websites through the credit gifting system 330 to purchase a gift credit in addition to or in replacement of their own online purchasing to reduce operating costs and increase their demographic information obtained through the credit gifting system 330. Retailers which are members of the credit gifting system 330 pay a membership fee which may be a fixed fee or a prorated fee based upon the volume/value of purchases made through the credit gifting system.

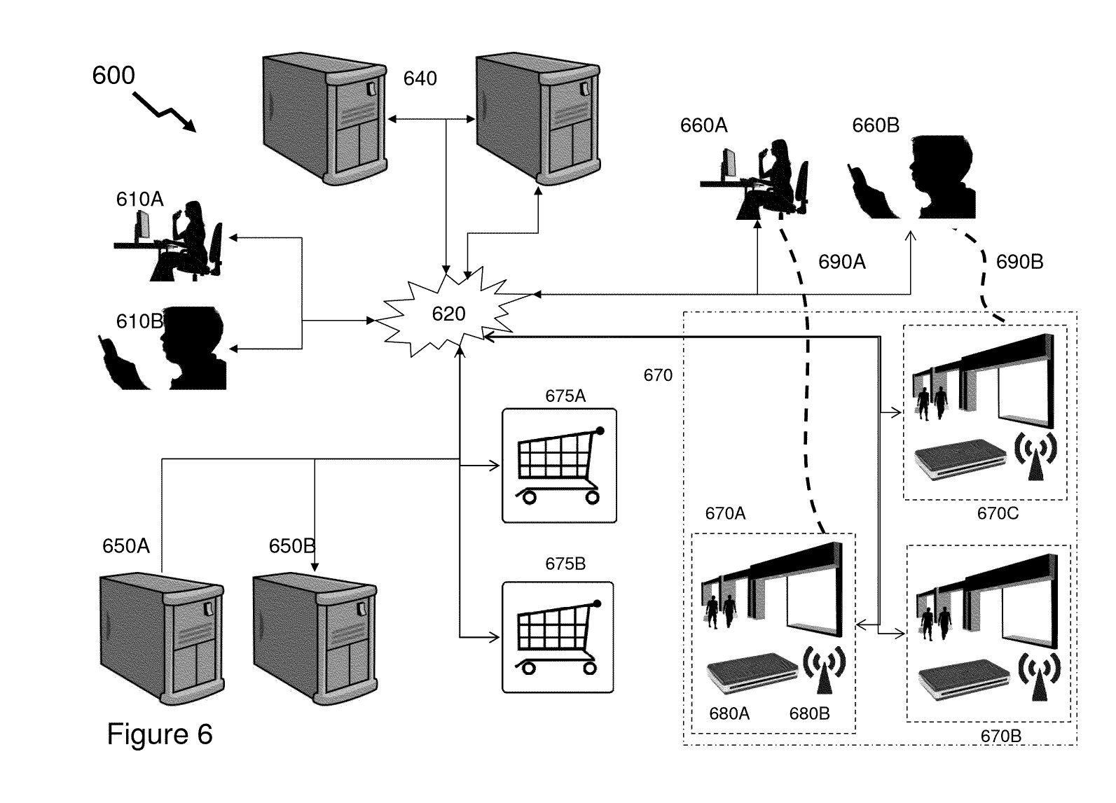

Referring to FIG. 4 there is a schematic 400 of credit gifting according to an embodiment of the invention. Accordingly as shown first giftor 410A accesses the credit gifting system 430 through a computer network 420, such as the Internet. In doing so they are presented with a series of prompts and requests for information which may be contained within a single web page or a plurality of web pages as would be evident to one skilled in the art. As such the first giftor 410A provides information relating to themselves including for example their name, address, age, credit card information or other information relating to a means of paying for the gift credit, i.e. a PayPal™ account and password. At this point the credit gifting system 430 also seeks authorization from the first giftor 410A in respect of using the financial instrument, i.e. credit card, PayPal™ etc. This authorization also includes approval to purchase the gift credit in whatever currency the gift credit is purchased in. This information may be associated with a user profile created by the giftor at that point in time or previously. They then access the list of member retailers who are part of credit gifting system, which may be via one of many methods known to those skilled in the art by selecting a geographic location, an area of interest, clothing, a list of retailers first giftor 410A has previously used or prefer, or a list of retailers the first giftee 450AA has previously used or prefer

Having worked through the selection process the first giftor 410A has now selected a retailer and an online retailer 440 associated with the retailer which meets a predetermined condition in respect of the first giftee 450A to whom they wish to send the gift credit. For example the online retailer 440 may be a general online resource across multiple product categories, i.e. Amazon, Nordstrom, eBay, or be specific in choice of goods and services to meet an interest of first giftee 450A, i.e. Pro Hockey Life, NFL, J. A. Henckels; or be associated with a location first giftee 450A will be in at a subsequent point in time such as traveling for pleasure or on business. The first giftor 410A then enters information relating to the first giftee 450A such as a name, electronic mailing address, etc. It would be evident for example that the first giftor 410A may have to provide some information as a default requirement whilst other information is optional and the first giftor 410A is told that this allows the credit gifting system 430 to subsequently provide other options to the first giftor 410A when they select a gift credit another time or send special offers to the first giftee 450A.

Once completed the credit gifting system 430 sends an electronic message to the online retailer 440 notifying them that first giftor 410A has purchased a gift credit for their store, for first giftee 450A. The retailer then issues to first giftee 450A an electronic message indicating that they have a gift credit at online retailer 440 that they may use. Associated with the electronic message sent by online retailer 440 to first giftee 450A may be advertising such as for example associated with the online retailer 440, associated with the wares/services that first giftor 410A used in selecting the online retailer 440, associated with a retailer within the wares/services that first giftor 410A selected, or first giftee 450A as they are known to online retailer 440 in their databases and information is selected based upon their demographic or purchasing history.

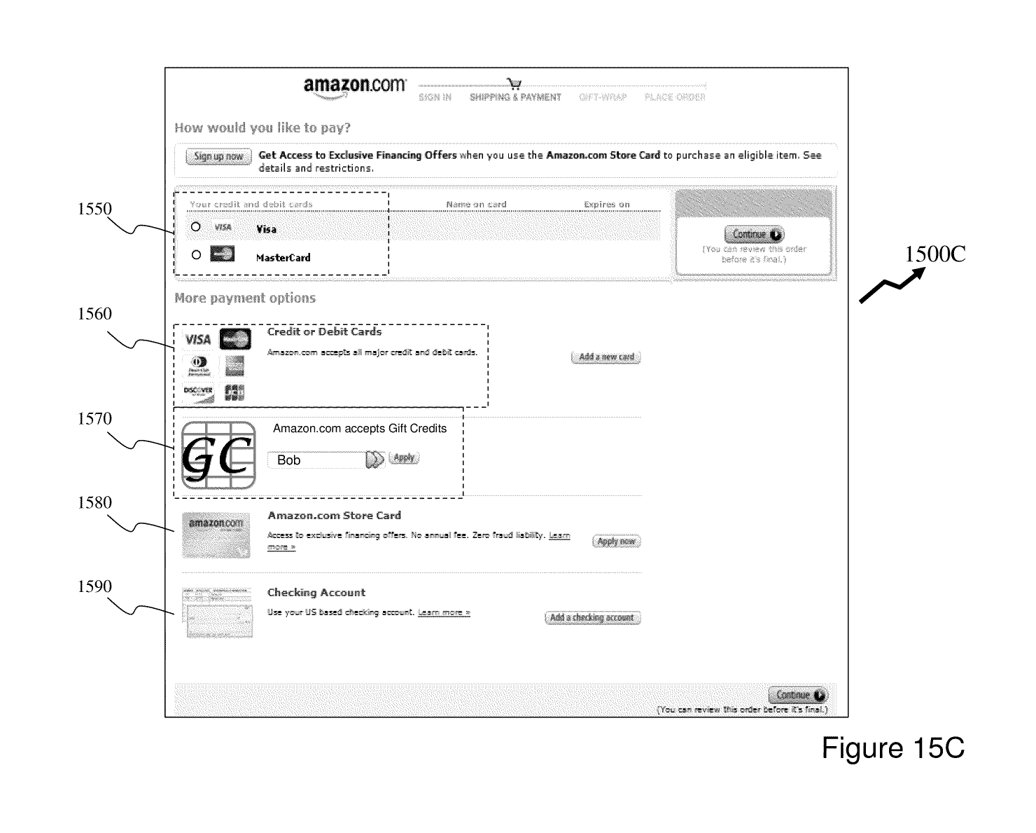

Accordingly, the first giftee 450A subsequently accesses the online retailer 440, selects a product or products they wish to purchase and proceeds to the checkout and redeems their gift credit as shown below in respect of FIG. 15B wherein their purchases are shipped to them in first dispatch process 460A. It would be evident that many options exist to provide the gift credit notification to the first giftee 450A as discussed below in respect of FIGS. 9 through 16 including but not limited to sending a notification to their email account, sending a notification to one of their social networks, and posting a notice to a social network. For example the email notification may be sent from the gift crediting system 430 and be structured as “Dear Fred, Happy Birthday, From Jane . . . Knowing your love of rock climbing Jane thought you might find something for climbing for your birthday” where multiple retailers are accessible to the first giftee 450A or alternatively may be from online retailer 440 where only one is specified and accordingly be “Dear Fred, Happy Birthday, From Jane . . . Knowing your love of rock climbing Jane thought you might find something at Mountain Equipment Coop for your birthday. We look forward to seeing you”. Optionally the gift credit may sent from the gift crediting system 430 using a proxy address that appears to the first giftee 450A to come from first giftor 410A.

Likewise second giftor 410B purchases a gift credit with online retailer 440 using the gift crediting system 430 for second giftee 450B. In this case the second giftor 410B has selected the gift credit to be restricted to a computer game for the Nintendo™ Xbox 360 gaming system but has elected to allow the second giftee 450B to redeem this with online retailer 440, e.g. Amazon, and physical retailers (not shown for clarity), e.g. Labyrinth Games at 645 Pennsylvania Av SE, Washington, D.C. 20003. Accordingly, the gift crediting system 430 notifies online retailer 440 that the second giftee 450B has a gift credit as well as the physical retailer. Upon full or partial redemption of the gift credit with one of the online retailer 440 and physical retailer their computer system communicates with the gift crediting system 430 to advise of the transaction wherein gift crediting system 430 transmits one or more messages to at least one of the online retailer 440, physical retailer and second gift 450 to update the gift credit records of the retailers as to the remaining credit or it's redemption and therefore removal from their systems, or the second giftor 410B to advise of the second giftor's 450B use of the gift credit. Optionally, where the giftee provides for options in the redemption of the gift credit the gift crediting system may advise the giftor of the giftee's purchase so that they are aware of what was chosen.

It would be evident that the online retailer 440 may provide additional advertising or special offers to the second giftor 450B. For example, such special offers being associated with the wares/services that second giftor 410B used in selecting the online retailer 440, or second giftee 450B as they are known to online retailer 440 in their databases and information is selected based upon their demographic or purchasing history. Similarly the special offer may to encourage use of the credit gifting system as the online retailer 440 has found that for every $1 spent from the gift credit the second giftee 450B spends another $1 whereas using “captive” traditional gift cards that additional spending is $0.35 for example per $1 on the traditional gift card used. Optionally, where the second giftee 450B redeems the gift credit with online retailer 440 the special offer or incentive may be provided to the second giftor 410B.

Within the foregoing description of a gift crediting method according to an embodiment of the invention as depicted by schematic 400 it would be apparent to one skilled in the art that in each communication described or implicitly required to perform an action that additional communications between credit gifting system 430, online retailer 440, first and second giftors 410A and 410B respectively, and first and second giftees 410A and 410B may be provided including but not limited to a receipt indicating the purchase of the gift credit for first giftee 450A, receipt from online retailer 440 to credit gifting system 430, and confirmation receipt from credit gifting system 430 to first giftor 410A when first giftee 450A redeems.

It would be evident to one skilled in the art that the credit gifting system, such as that described in respect of credit gifting systems 330 and 430 in FIGS. 3 and 4 respectfully supra, is a software application or group of software applications that provide the multiple functions required, including but not limited to establishing the catalog of recommended retailers, locations of all outlets of recommended retailers, catalogs of items available for purchase with geographic restrictions/limitations if appropriate, browsing and “cart” features for giftor to select and store purchases, “check out” for giftor to purchase gift credit(s), communications to advise retailer/giftee of the gift credit purchases, clearing financial transactions, etc. This application or applications being hosted on one or more computer servers that may be located geographically proximate to distant to one another. Further, the gift crediting system may be hosted on multiple computer server clusters dispersed around a country, state, province, economic area, continent, etc.

In some instances, the communications to/from the gift credit system and/or gift crediting application may require authorization from the giftee and/or giftor to send electronic messages and/or access electronically stored data associated with their accounts. For example, the giftee may authorize to use their Blackberry Messenger address as an alternative to their Yahoo email address or the giftee may authorize/refuse access to their social network accounts which allow the gift crediting system to retrieve preferences for the giftee. Many other scenarios would be evident to one skilled in the art.

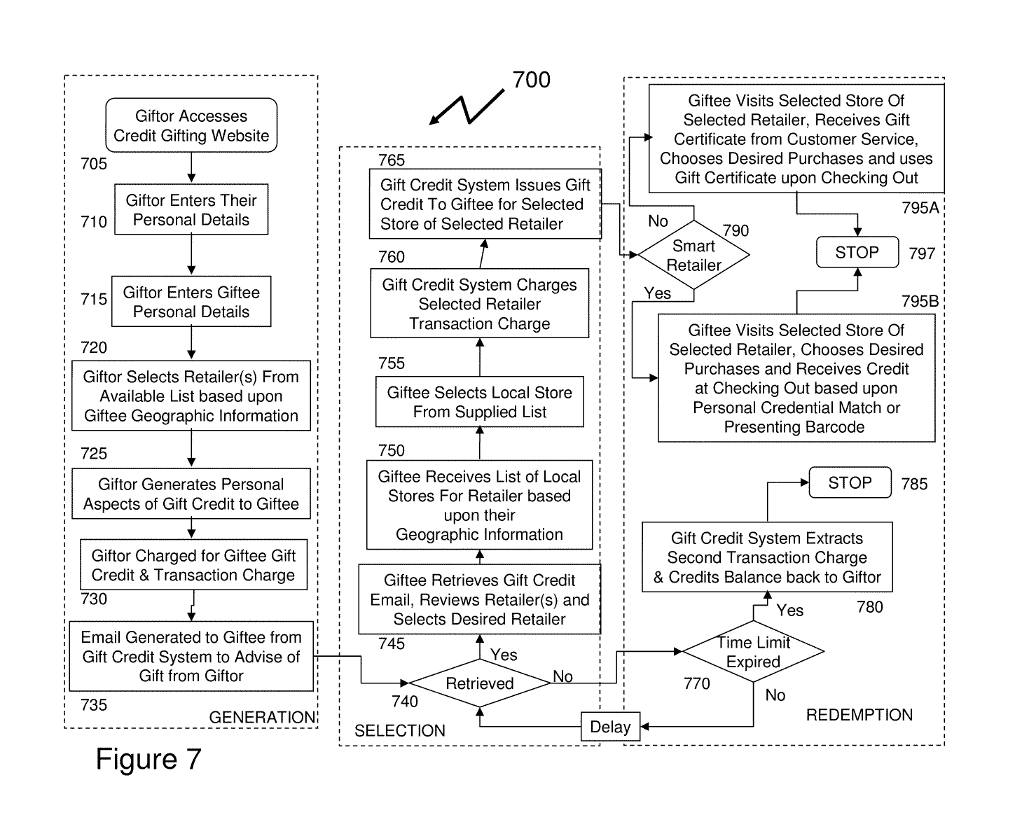

Now referring to FIG. 5 there is shown a schematic 500 of credit gifting according to an embodiment of the invention. Accordingly first and second giftees 560A and 560B respectively are advised of gift credit based upon information provided by the credit gifting system 530 in response to a purchase of the gift credits being made by first and second giftors 510A and 510B respectively. In this embodiment of the invention the first and second giftors 510A and 510B have each selected a retail chain 550 without further restriction thereby allowing the first and second giftors 560A and 560B to select the store from which to redeem the gift credit. As will be evident this selection process may be varied for each of first and second giftees 560A and 560B respectively. Accordingly as shown each of first and second giftors 510A and 510B access the credit gifting system 530 through a computer network 520, such as the Internet. In doing so they are presented with a series of prompts and requests for information which may be contained within a single web page or a plurality of web pages as would be evident to one skilled in the art. As such the first and second giftors 510A and 510B provide information relating to themselves including for example their name, address, age, credit card information or other information relating to a means of paying for the gift credit, i.e. MasterCard, VISA, American Express, or a PayPal™ account and password if required. At this point the credit gifting system 530 also seeks authorization from the first and second giftors 510A and 510B in respect of using the financial instrument. This authorization also includes approval to purchase the gift credit in whatever currency the gift credit is purchased in. This information may be associated with a user profile created by the giftor at that point in time or previously.

The first and second giftors 510A and 510B then access the list of member retailers who are part of the credit gifting system 530 and work through the selection process. The giftor 510 has now selected a retailer chain 550, comprising first through third stores 550A through 550C respectively, which meets a predetermined condition in respect of the first and second giftees 560A and 560B to whom they wish to send the gift credit. For example the retailer chain 550 may be unique to the area around the home or office of either of first and second giftees 560A and 560B, be specific in choice of goods and services to meet an interest of first and second giftees 560A and 560B, be associated with a location first and second giftees 560A and 560B will be in at a subsequent point in time such as traveling for pleasure or on business.

The first and second giftors 510A and 510B then enter information relating to the respective first and second giftees 560A and 560B such as a name, electronic mailing address and other details they wish to release. It would be evident for example that the first and second giftors 510A and 510B may have to provide some information as a default requirement whilst other information is optional and the first and second giftors 510A and 510B are told that this allows the credit gifting system 530 to subsequently provide other options when they select a gift credit another time or send special offers to the first and second giftees 560A and 560B.

Once completed the credit gifting system 530 sends an electronic message to the retailer server 540 of the retail chain 550 notifying them that first and second giftors 510A and 510B have purchased gift credit for their stores, for first and second giftees 560A and 560B respectively. The retailer, in this instance, then issues from their retailer server 540 to first and second giftees 560A and 560B electronic messages indicating that they have a gift credit for the retailer chain 550 that they may collect and use. For example, this electronic message to first giftee 560A may for example say “Dear Jane, Knowing your love of makeup Fred thought you might find something here at MAC Essentials for your birthday” wherein “Jane” is associated with the first giftee 560, “Fred” with the first giftor 510A and “MAC” with retailer chain 550. Associated with the electronic message sent by retailer chain 550 to first giftee 560A may be advertising such as for example associated with the retailer chain 550, associated with the wares/services that first giftor 510A used in selecting the retailer chain 550, or first giftor 560A as they are known to retailer chain 550 in their databases and information is selected based upon their demographic or purchasing history. Optionally this advertising may be specific to one store, e.g. first store 550A, within the chain 550 which is identified as the closest to first giftee 560A or has a larger department associated with the wares/services relating to first giftee 560A. Based upon this gift credit and advertising the first giftee 560A goes to first store 550A in process 570A and makes a purchase.

Second giftee 560B similarly receives an electronic message from the retailer server 540 which may for example say “Dear Paul, just a little something to get a few things you need at University, love Mom and Dad” wherein the second giftor 510B. In this instance the second giftor 510B has elected to use a personal message rather than one automatically generated by the retailer server 540. Whilst the electronic message indicates that the second giftee 560B has received a gift credit with retailer chain 550 but does not include advertising specific to any of the first to third stores 550A, 550B, and 550C. Accordingly, the second giftee 560B may determine to proceed to third store 550C based upon its being close to the University and offering a student discount. Second giftee 560B proceeds therefore to third store 550C, with the gift credit as accessed through the gift crediting application loaded onto their portable electronic device. Retailer chain 550 being a business equipment and supplies retailer has implemented NFCPOS as well as Wi-Fi 580B in their stores such that when the second giftee 560B enters the store their portable electronic device establishes an ad-hoc network with the Wi-Fi 580B and therein communicates to the in-store server 580A. As such the second giftee 560B can proceed to make their selections and complete the purchasing transaction using NFCPOS wherein the point-of-sale terminal is now aware of the credit with the retailer chain 550 arising from the gift credit and credits this to the transaction. If the gift credit is smaller than the transaction then the NFCPOS process results in payment of the remaining outstanding costs due. In some instances, as evident below in respect of FIG. 10 the second giftor 510B may have established an “overage” on the gift credit such that if it is within a fixed percentage or fixed monetary value the increased value is used in the resulting transaction.

Within the foregoing description of a credit gifting method according to an embodiment of the invention as depicted by schematic 500 it would be apparent to one skilled in the art that in each communication described or implicitly required to perform an action that additional communications between credit gifting system 530, retailer chain 550, retailer server 540, first to third retail stores 550A, 550B, and 550C, first and second giftors 510A and 510B, and first and second giftees 560A and 560B may be provided including but not limited to a receipt indicating the purchase of the gift credits for first and second giftors 510A and 510B, receipt from retailer chain server 540 to credit gifting system 530, and confirmation receipt from credit gifting system 530 to first and second giftors 510A and 510B when first and second giftors 560A and 560B redeem their gift credits.

Within the embodiment presented supra in respect of FIG. 5 it was discussed that the advertising provided together with the gift credit may be associated with a particular store within the retail chain or the retail chain itself. Where the advertising relates to a specific retail store then the selection of the particular retail store would be based upon the information within the credit gifting system by the giftor or associated by the giftee from their previous activities, such as for example one store may be closer to the giftee but they have a history of making purchases from a second further location. However, it would be apparent that this advertising may be dynamically associated with the giftee at the point they receive the gift credit from the giftor. This, for example being determined by obtaining from a network a current location, for example by cellular base station triangulation (as used for example in Google® Maps) or alternatively by sending a first message triggering a GPS location return and then sending a second message based upon that GPS location. In general, the former is easier as it does not require the user to authorize providing the GPS location for example. Accordingly, the advertising is associated with their current location. Alternatively, once the giftee has received the gift credit, but not redeemed it, if their portable electronic device associates with a Wi-Fi of that retail chain they may be provided a reminder from the gift credit application that they have this credit with that retailer or a group of retailers wherein this retailer is one of them.

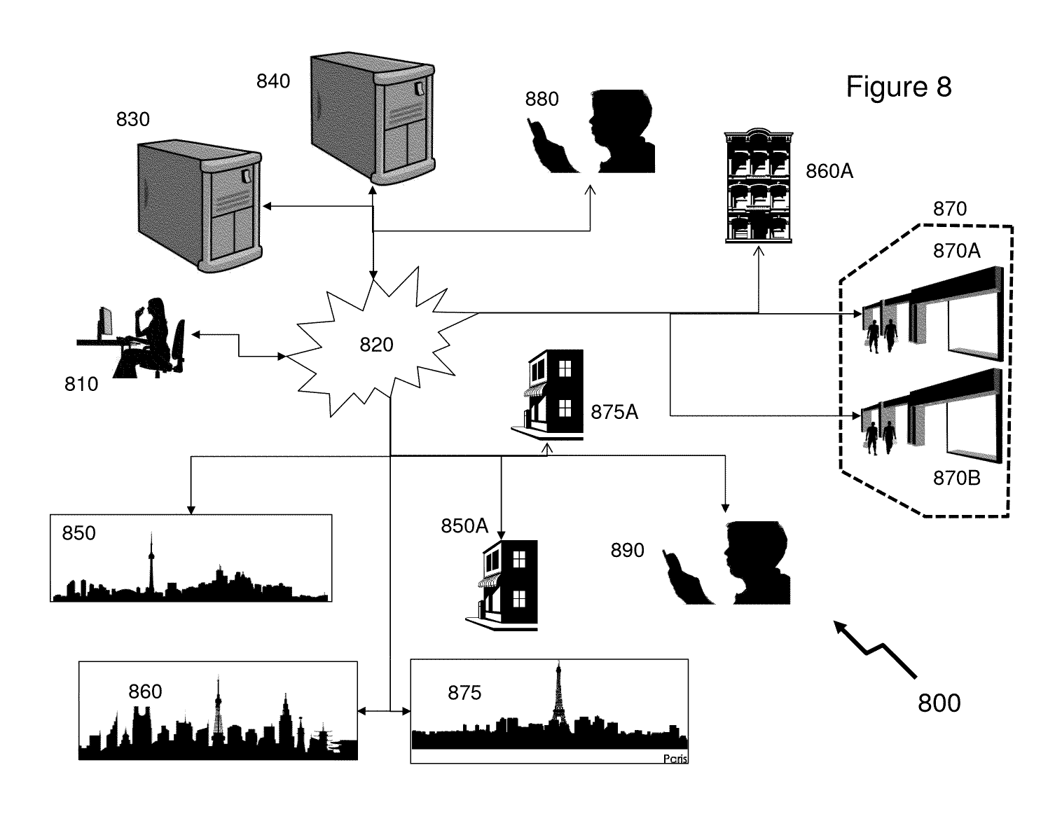

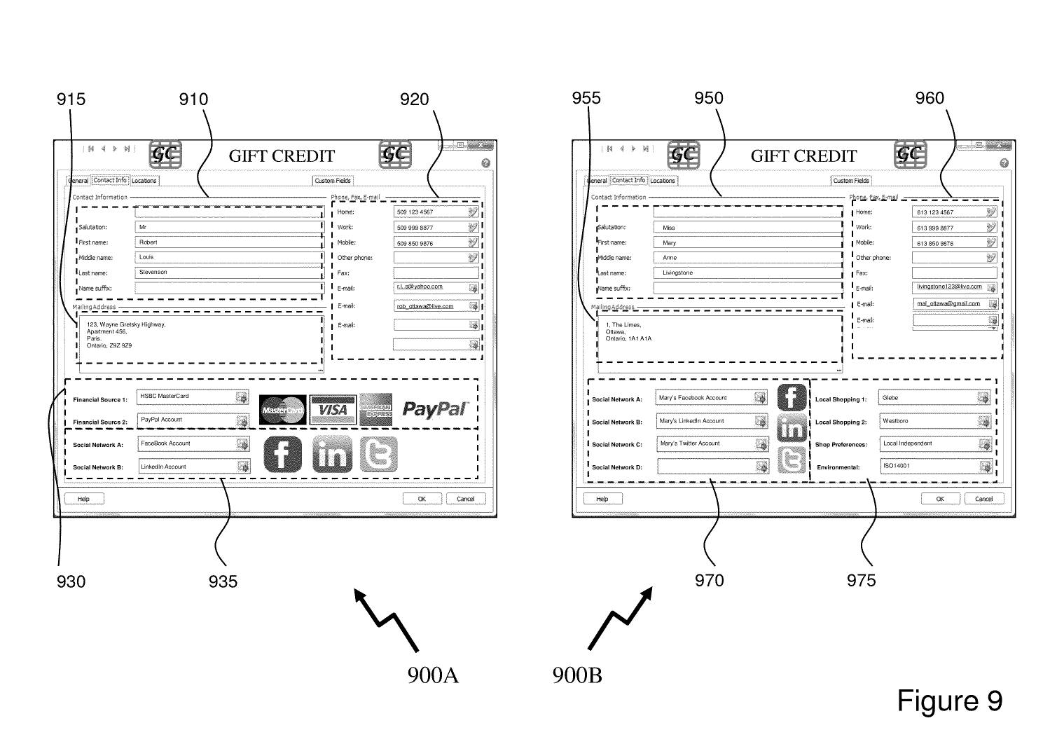

Now referring to FIG. 6 there is shown a schematic 600 of a credit gifting system 630 according to an embodiment of the invention wherein a first giftee 690A is advised of the gift credit based upon information provided by the credit gifting system 630 and can select the retail store from which to redeem the gift credit. Accordingly as shown a first giftor 610A accesses the credit gifting system 630 through a computer network 620, such as the Internet, and completes the necessary information within the gift crediting application to purchase a gift credit for first giftee 660A. Such a process being such as described above in respect of FIGS. 3 through 5 or described below in respect of FIGS. 7 through 16.

Having worked through the selection process the first giftor 610A has now selected a retailer chain 670, comprising first through third stores 670A through 670C respectively, which meets a predetermined condition in respect of the first giftee 690A to whom they wish to send the gift credit. First giftor 610A also designates secondary retailer chains 675A and 675B that provide back-up options to the first giftee 660A should there be a problem with retailer chain 670 such as bankruptcy etc. Since the credit gifting system 630, according to embodiments of the invention, does not transfer funds to retailer chain 670 until the first giftee 690A collects the gift credit in process step 690A then should an issue arise the credit gifting system 630 can advise first giftee 690A and first giftor 610A that an alternative retail chain is now available to complete the gift credit process through. Such a feature is not possible with gifting prior art “captive” gift cards.

Upon receipt of an electronic message from credit gifting server 630 the first giftee 660A may access the credit gifting system 630 or retailer server 640 associated with the retail chain for which the gift credit is provided to retrieve information relating to the stores, i.e. first through third stores 670A through 670C respectively forming part of retail chain 670, to which the gift credit relates. At this point additional advertising may be provided to the giftee 690 either relating to the retailer chain 670 or specific stores, for example first store 670B as it, for example has just received a new delivery of Alsace wines and it is known by retailer server 640 that first giftee 660A has bought Alsatian wines previously. Accordingly, first giftee 660A completes a purchase at first store 670A through process step 690A. Optionally the advertising may be enabled/disabled by the giftee 690 such a through an opt-in/opt-out feature for example.

If an event occurs with retailer chain 670 such as bankruptcy of the entire chain or closure of a predetermined portion of stores within the chain associated with a geographic area that prevents first giftee 660A from redeeming their gift credit then first giftee 660A can re-access credit gifting system 630 using a hyperlink for example embedded within the original electronic message or be contacted by the gift crediting system 630 as this issue had been entered into the system, for example, by messages from other giftees, from information provided by the retailer chain 670, or retrieved from other financial/commercial resources. Optionally, it is first giftee 660A themselves that flags that the first store 670A to which they had the gift credit from first giftor 610A is associated with a store that is now closed or associated with a retail chain that is now bankrupt. Upon verification of the closure/bankruptcy the credit gifting service 630 provides first giftee 660A with details of secondary retailer chains 675A and 675B that were identified by the first giftor 610A, or selected automatically by the gift crediting system. First giftee 660A can then select an alternate retailer chain from the secondary retailer chains 670A and 670B and then proceed to redeem the gift credit. When the first giftee 660A makes this selection the gift crediting system 630 provides the requisite information regarding the gift credit within the associated secondary retailer servers 650A and 650B according to the selection of the one of the secondary retailer chains 675A and 675B respectively.

Likewise second giftee 660B receives a gift credit from second giftor 610B from the gift crediting system relating to retailer chain 670 and proceeds to make a purchase from third store 670C of the retailer chain 670 using the gift credit. However, an issue arises with their purchase and the warranty instructions from the manufacturer are to return the defective product back to the retailer they purchased it from. However, in the intervening period retailer chain 670 has gone bankrupt and therefore the second giftee 660B cannot return the defective product through that channel. Also, as happens in many instances they threw the receipt away. However, now the second giftee 660B may contact the gift crediting system 630 in respect of their issue with the bankruptcy of retailer chain 670. Upon verification by the gift crediting system 630 that the second giftee 660B purchased the product in question and that retailer chain 670 has gone bankrupt the gift crediting system 630 may provide the second giftee 660B with the names of the secondary retail chains 675A and 675B and provide the associated secondary retailer servers 650A and 650B of the secondary retailer chains 675A and 675B respectively with confirmation information that the second giftee 660B purchased the product with a gift credit issued by the gift crediting system.

It would be evident to one skilled in the art that alternate approaches to dealing with the bankruptcy or cessation of business of a retailer exist. Such approaches include but are not limited to issuing a credit card company insurance that the gift credit is redeemable elsewhere without penalty, issuing a redemption against a credit card owned by the giftee, through refund as a result of insurance with the credit card company, or PayPal™ etc, used to purchase the gift credit, retailer compliance to keep funds associated with gift credit activities within a trust fund not connected with the retailers daily commercial activities.

Referring to FIG. 7 there is shown an exemplary flow diagram 700 according to an embodiment of the invention. The process begins at step 705 wherein a giftor accesses the gift credit website and at step 710 enters their personal details followed by the personal details of the giftee at step 715. In step 720 the giftor is presented with a list of retailers based upon the giftee's geographic information and selects the retailer they wish to use for the giftee to redeem their gift at. Next in step 725 the giftor generates personal aspects of the gift credit to the giftee whereupon in step 730 the process progresses to charging the giftor for the value of the gift credit and a service fee. The giftor having previously given authorization for the gift credit and any applicable service fee to be charged to their financial instrument of choice, e.g. credit card. In step 735 the credit gifting system generates an email to the giftee advising them of the gift from the giftor.

Next in step 740 the credit gifting system checks to see if the gift credit has been retrieved by the giftee. If yes then process moves to step 745, but otherwise moves to step 770 wherein the system checks to see if a predetermined time limit has expired. If the time limit has not expired the process cycles back to step 740 with a time delay before it checks again to determine if the gift credit has been retrieved. When the gift credit is retrieved the process moves to step 745 where the giftee reviews the retailers services and/or products and selects the desired retailer to redeem the gift credit from and the process moves to step 750 wherein the giftee is presented with the list of local stores us provided based upon their geographical location and in step 755 the giftee selects the local store they wish to go to. At this point the process moves to step 760 and the selected retailer is automatically charged the retailer service charge associated with the gift credit process before the process moves to step 765 and the credit gifting system issues the final transaction data assigning the gift credit for the giftee to the selected store for the selected retailer.

The process then moves to step 790 wherein the determination is made as to whether the retailer is a “smart” retailer or not. If not then the process moves to step 795A after a notification has been sent to the giftee that the gift credit has been processed and that they should visit the customer service desk at the store they selected. In step 795A the giftee visits the customer service desk and is given a traditional gift card, such as described supra in terms of a personalized traditional gift card, makes the selection of their desired purchase and proceeds to redeem the traditional gift card against this purchase, whereupon the process moves to step 797 and stops.

If the determination in step 790 is that the retailer is a “smart” retailer the process moves to step 795B after a notification has been sent to the giftee that the gift credit has been processed and that they should use a financial instrument identifying themselves to the retailer financial transaction system. Accordingly the giftee visits the retailer, chooses their desired purchase and proceeds to the check-out whereupon when their purchase is processed. Either the payment transaction during execution interacts with the retailers system which acknowledges the gift credit and debits this to the transaction or the giftee presents a retail purchase system compatible barcode. For example, the financial instrument being a credit card, and again the process moves to step 797 and terminates.

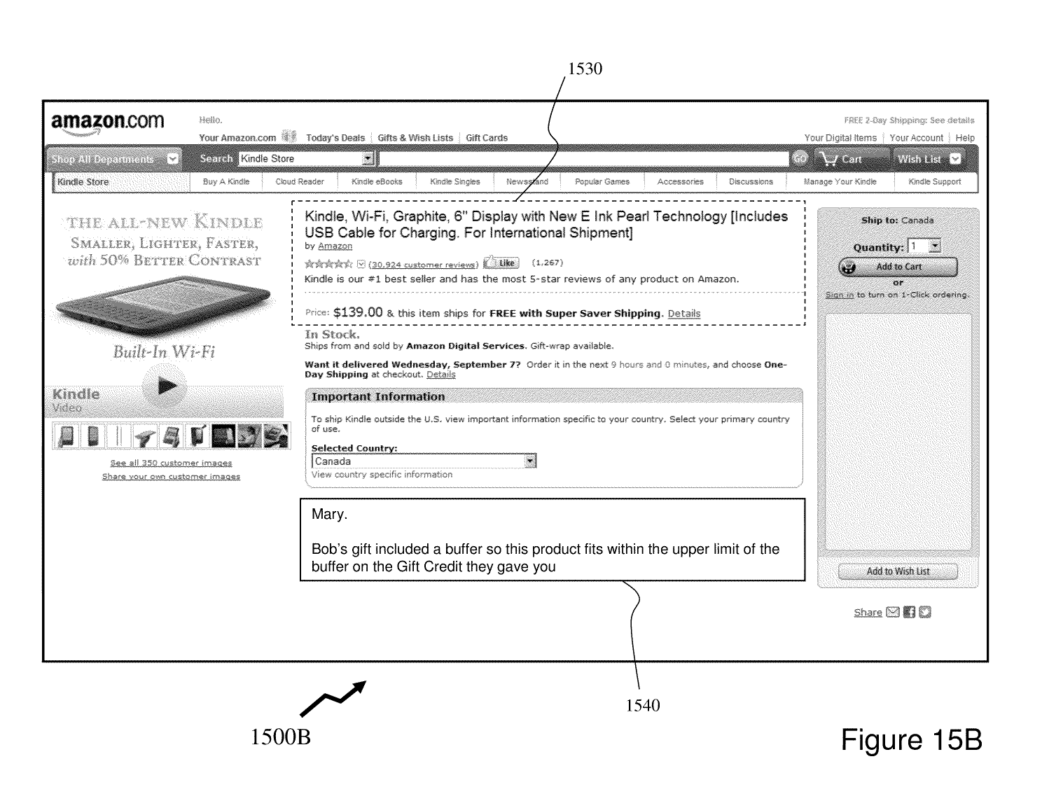

If in step 770 the process determines that the predetermined time limit has elapsed then the process moves to step 780 wherein the credit gifting system extracts a second service charge from the value of the gift credit and credits the balance back to the giftor, whereupon the process moves to step 785 and terminates. Optionally, the presentation of a retail purchase system compatible barcode may be a 2D barcode such as depicted in FIG. 14 or a conventional barcode. Alternatively, the presentation of information may be performed wirelessly or through a near-field communications system.

As described supra in respect of FIGS. 3 through 7 the credit gifting system may operate globally allowing for example a giftor in Ottawa, Canada to provide a gift credit to a giftee in Greece, or the giftor in Ottawa, Canada to provide the gift credit for a giftee living in Ottawa but who is going to London, England for a vacation. As such it is possible that the value of the gift credit purchased for the giftee does not entirely cover the cost of the selected item when the giftee redeems the gift credit as prices have been adjusted in the interim. It would be evident to one skilled in the art that in instances where the gift credit is very specific that the credit gifting system may not indicate a value and the giftee redeems the gift credit without being aware of this issue. In this scenario retailers within the credit gifting system as part of their membership may warrant to provide specific items at the retail pricing advertised when purchased and over/under pricing variations are an overall aspect of being in business which over time null out. Alternatively the retailer may indicate to the giftor at time of purchase that they warrant the gift credit for up to +10% price variations for example, or some other amount determined by the retailer either territorially, product line based, or specific product based.

It would evident that the giftor could provide pre-authorization to charge their financial instrument with another charge based upon the difference between the actual redeemed gift cost and the purchased gift value with such variation limits or that the difference would be born by the giftee. Equally, the price adjustment may have reduced the retail price of the item. As such the credit gifting system may redeem to the giftor the unused balance of the gift that was not redeemed by the giftee in obtaining the item specified or selected. Optionally, this refund may incur a handling fee or may only be initiated at a specific threshold as part of the terms of the agreement that the giftor accepts when registering with the credit gifting system Likewise in an instance wherein the gift credit is not redeemed after a predetermined period of time or has only been partially redeemed at that predetermined period of time that the unused portion of the gift credit may be returned to the giftor with or without a handling fee according to either the management practices of the provider of the system or the policies of the retailer wherein the gift credit was specific to a retailer.

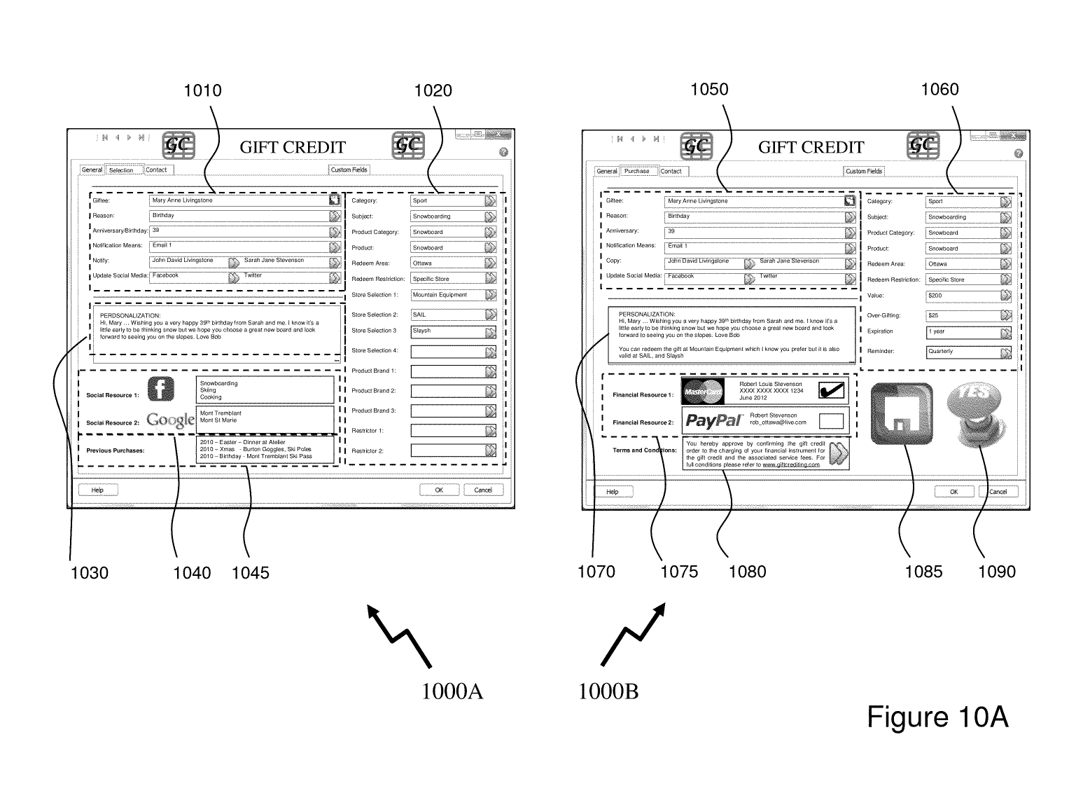

Now referring to FIG. 8 there is presented a schematic 800 of a credit gifting system 830 according to an embodiment of the invention wherein the giftee 880 is advised of the gift credit based upon information provided by the credit gifting system 830 and that the giftor 810 has selected retailer chain 870 and first store 870A for them to redeem the gift credit from. However, the giftee 880 is either unable to redeem the gift certificate from retailer chain 870 and first store 870A. Accordingly as shown a giftor 810 accesses the credit gifting system 830 via a computer network such as the Internet 820 for example and defines a retailer chain 870 from which giftee 880 can redeem the gift credit. As with the other embodiments presented supra in respect of FIGS. 3 through 7 the process of gifting the gift credit also results in communication with retailer server 840 of the retailer chain 870. Upon receipt of the gift credit the giftee 880 enters the credit gifting system 830 and selects first store 870A from first store 870A and second store 870B to collect the gift credit from.

However, giftee 880 is going to be unable to redeem the gift credit due to for example an accident, relocation for work, etc. As such giftee 880 is able to access the credit gifting system 830, using for example a credit gifting application on their portable electronic device, and notify that they wish to transfer the gift credit to a third party 890 in order for it to me redeemed. If at that point giftee 880 indicates that the third party 890 will collect the gift credit at the first store 870A or another store within retailer chain 870 such as second store 870B then the records of the credit gifting system 830 and retailer server 840 are updated and an email sent to third party 890 indicating that giftee 880 has requested they go to the store within retailer chain 870 and redeem the gift credit on their behalf. Third party 890 when receiving the notification is able to alter the selection made by the giftee 880 of either first store 870A or second store 870B to redeem the gift credit at as circumstances may make it easier for them to do so that were unknown to the giftee 880 when they entered the selection in requesting the transfer.

Accordingly, third party 890 proceeds to, for example, second store 870B and redeems the gift credit on behalf of the giftee 880. Redemption of the gift credit by third party 890 is registered by credit gifting system 830 that cross-references this to the original gift credit issued to giftee 880 and thereby if the giftor 810 was to receive an acknowledgement that the gift credit was redeemed then the credit gifting system 830 issues such an acknowledgement. Other aspects of the credit gifting system 830 relating to the gift credit are maintained in association with the giftee 880 irrespective of redemption by third party 890.

However, if the gift credit was issued without restriction to the retailer or with sufficient rights attached to allow the giftee to change the retailer if predetermined, then giftee 880 may elect to have the gift credit redeemed by the third party 890 who is resident in another city or country. Accordingly, in this embodiment giftee 880 is in Washington and accordingly can assign the gift credit to third part 890 and specifies redemption for the third party 890 which may for example be “Nordstrom” 850A in Seattle 850, “Shinjuku” 860A in Tokyo 860, and “Printemps” 875A in Paris 875. Once giftor 880 selects for example “Nordstrom” 850A in Seattle 850 the credit gifting system communicates with the retailer server 840 to cancel the gift credit, the servers of “Nordstrom” 850, not shown for clarity, to establish the new gift credit, and third party 890.

It would be apparent to one skilled in the art that the credit gifting system 830 may request a service fee from giftee 880 for moving the gift credit to another retailer and that this service fee may be different if the retailer is within the same city but different if the retailer is in a different city, country etc. Optionally the credit gifting system 830 may waive the service fee if desired or if the third party 890 is still going to redeem the gift credit at the original first store 870A.

Now referring to FIG. 9 there are shown first and second display screens 900A and 900B of a credit gifting application according to an embodiment of the invention wherein a giftor establishes a user profile and a giftee profile respectively. Referring to first display screen 900A the giftor enters information relating to themselves to establish a user profile with the gift crediting application. Accordingly in name block 910 they enter their name, in address block 915 their address, and in contact block 920 they enter contact details such as telephone numbers, email etc. Then within financial block 930 they enter details relating to financial instruments that they will use when purchasing gift credits, which for example are shown as a HSBC MasterCard and PayPal™ account, whereas others may include, but are not limited to, Visa, American Express, Discover, Capital One, etc as well as where arrangements can be made by the gift crediting application with financial institutions the giftor's checking account for example, by making charges to a store charge card, e.g. Sears, or via advances from Western Union for example. Further in social block 935 the giftor enters information relating to their social networks that allows the gift crediting application to retrieve preferences of their friends, contacts etc by logging into the social media networks using the giftor's credentials. As shown the giftor has entered Facebook™ and LinkedIn™ as these social media networks. Other examples may include, but are not limited to, for example Twitter, Friendster, Myspace, Orkut, Hi5, Google+, Plaxo, and XING

Optionally, the giftor may establish all the necessary credentials within the financial block 930 and social block 935 to allow automatic retrieval of social media information or use of the financial instruments. Alternatively, the gift crediting application may be established by the giftor to request the credential verification information each time they log into the gift crediting application and update information regarding their giftees or making a gift credit purchase. It would be apparent to one skilled in the art that a giftor/giftee may access the gift credit application and/or gift credit system through other portals, including but not limited to social networks such as Facebook™ and Twitter™ etc, electronic mail or browser applications such as Google™, Yahoo™, Internet Explorer, etc, and retailer websites, for example Sears™ Amazon™. For example, a user may be given the option at a checkout on a retailer's website to gift credit rather than purchase/ship or choose to gift credit the identified item directly through a mouse operation such as a right-click or dragging the item to a gift credit icon or vice-versa.

In second display screen 900B the giftor enters information relating to a giftee that they wish to establish within the gift crediting application and purchase a gift credit for. Accordingly in name block 950 the giftor enters the first name, last name, salutation, etc relating to the giftee whilst in address block 955 the address of the giftee is entered which may for example be used to ship a traditional gift card to the giftee or by a retailer within the gift crediting application to send a purchase to the giftee when they redeem the traditional gift card. Accordingly, if this information is entered by the giftor it makes the experience of the giftee more straight-forward with less onerous entry of data. Optionally, the gift crediting application may incent the giftor to enter this data as it increases the likelihood that the giftee will subsequently use the gift crediting application themselves to purchase for another giftee.

In contact block 960 the giftor enters information relating to the giftee including telephone numbers and email addresses. In social media block 970 the user enters references to social network entries relating to the giftee. If the giftor entered social network information in first display screen 900A the gift crediting application may automatically populate some of the fields in social media block 970 by cross-referencing the name block 950 data with friends, contacts etc within the social media. Alternatively, the gift crediting application may when a user enters a social network name by typing or selecting an icon opens that social media application such that the giftor searches for the giftee and indicates when they have the right individual. In preferences block 975 the giftor enters information relating to preferences of the giftor including for example, but not limited to, favorite shopping district(s), preference of style of shop e.g. local independent rather than national chain, and environmental aspect e.g. is the retailer accredited to a recognized environmental programme such as ISO 14001 or partner to a programme or charity.

The gift crediting application may direct the giftor to enter information is a particular order by automatically moving to the next box upon entry of the current field. Optionally, after the giftor has entered information in the name block 950 and address block 955 the gift crediting application may search its database to see if the giftee is already registered and accordingly advise the giftor that is has identified the giftee as an existing member and ask if the giftor wishes the gift crediting application to automatically populate fields it has data for before allowing the giftor to add other information.

Referring to FIG. 10A there are shown first and second display screens 1000A and 1000B respectively relating to a credit gifting application according to an embodiment of the invention wherein a giftor establishes and confirms a gift credit to a giftee. Within first display screen 1000A the giftor enters information in giftee block 1010 including for example the name of the giftee, which may be selected from a list of established giftees by the giftor, the reason for the gift credit, a number relating to the anniversary or birthday, and notification means. The giftor may then elect to notify other individuals, such as others established with profiles in the credit gifting application or by entering their email addresses. These individuals would receive an email from the credit gifting application advising that the giftor has sent a gift credit to the giftee with information relating to the restrictions applied to the gift credit, the reason for sending the gift credit, etc but absent financial data, personal message etc. In this manner others may be reminded of the forthcoming event and what the giftor has purchased thereby avoiding missed anniversaries, birthdays etc or duplicate gifts. Next the giftor may select social media references wherein a posting to the social network profile or account of the giftor would be made upon their completion of the gift credit process. Accordingly, for example the giftors Facebook™ page has an entry stating that they just sent a gift credit using the credit gifting application to the giftee.

In message block 1030 the giftor can enter a personal message to the giftee. According to this embodiment of the invention no entry in this message block 1030 results in the credit gifting application automatically creating one using the information within first and second display screens 1000A and 1000B respectively according to the protocol established by default in the credit gifting application. Within social block 1040 retrieved preference information from social media networks is presented to the giftor automatically based upon the retrieval of this information from a social network crawler application that searches the giftee social media identified in second display screen 900B in FIG. 9 above. As shown, for example, for “Mary Anne Livingstone” the credit gifting application presents “Snowboarding”, “Skiing”, and “Cooking” from Facebook™ and “Mont Tremblant” and “Mont St Marie”, which are both winter sports resorts, from Google™. Next in history block 1045 the credit gifting application presents a history of gifts from the giftor to the giftee. In this instance the history block 1045 indicates that the giftor selected a dinner for Easter 2010, goggles and ski poles for Christmas 2010 and a Ski Pass to Mont Tremblant for their birthday in 2010. The entry in giftee block 1010 indicating that the giftor is selecting a birthday present again.

In restriction block 1020 the giftor through a series of drop-down dialog boxes is able to restrict the gift credit redemption as widely or narrowly as they wish. In this instance, the giftor has selected to narrow the redemption to “Sport”, “Snowboarding”, and “Snowboard” for the product aspects and “Ottawa” for the geographical restriction and “Mountain Equipment”, “SAIL”, and “Slaysh” as specific retailers. The giftor has not elected to restrict the selection to a specific brand or brands nor add other restrictors.

Next in second display screen 1000B after completing the giftee related aspects of the gift credit the user enters those relating to the financial aspects, delivery, etc of the gift credit. In giftee block 1050 the giftee, gift credit reason, notification means etc are presented to the giftor. Next in personalization block 1070 the message to be sent is displayed which comprises the personalization entered by the giftor in first display screen 1000A together with information derived from the restrictions. In other instances this additional information may be formatted differently according to the restrictions applied and whether an entry has been made by the giftor. In financial block 1075 the giftor is presented with their financial instruments, in this case MasterCard and PayPal™ wherein the giftor has selected to pay in this instance using MasterCard.

Next in condition block 1080 the giftor is presented with a summary terms and conditions with reference to the full terms and conditions. Gift block 1060 presents some of the product selection and restriction information from the first display screen 1000A but the giftor now enters the value of the gift credit, $200, and has elected an over-gift of $25 although they could have selected a percentage or none. The over-gift allows the giftor to give some latitude in the gift credit such that should the item be above $200 but under $225 the giftee may still purchase the product with the gift credit but without paying anything additional themselves. The giftor can also establish an expiration of the gift credit, in this instance they have selected 1 year, and a reminder period, in this instance quarterly wherein the giftee will be reminded of the gift credit if they have not redeemed it. If after a year however the gift credit has not been redeemed the gift credit expires and the money charged to the giftor returned, with a handling or convenience fee deducted. Finally, the giftor is presented with a save button 1085 and order button 1090 wherein they may save the gift credit for subsequent purchase and make the purchase. Optionally, upon the user selecting the order button 1090 the credit gifting application may proceed directly to verify the transaction or present a second confirmation screen within which the user must make a confirmation of the order.

Optionally, when the giftor is making selections or restrictions to the gift credit, such as for example geographical restrictions, retailer restrictions, etc such as described above in respect of FIG. 10A the giftor may be able to elect to select based upon the current location of the giftee rather than defaulting to a home location, work location, or entry selected by the giftor based upon their knowledge of the giftee. The current location being determined for example by a GPS signal from the giftee's portable electronic device, current association to a network, etc. In other instances, the geographical restriction may be established as being a combination of locations or selections made by the giftor, which may include their own location or the location of their own portable electronic device. Optionally, the expiration of the gift credit may be defaulted by the gift credit application and/or gift credit system to a predetermined period of time if the giftor does not make a selection, for example 2 years.

Now referring to FIG. 10B there is shown a display screen 1000C of a gift crediting application according to an embodiment of the invention wherein a giftor establishes a product filtering based upon the catalogs of retailers that are members of the credit gifting system. Accordingly, as discussed above in respect of FIG. 10A for first display screen 1000A the giftor may restrict the gift credit using a hierarchy of drop-down dialogs such as presented in restriction block 1020. These as indicated allow the giftor to restrict the gift credit from a single product at a specific retailer to completely open without any product or retailer restriction. In the event that the giftor is restricting to a level below that of a general retailer the credit gifting system may present a catalog style display to the giftor allowing them to make selections. As displayed the giftor has selected through navigation pane 10100 climbing gear and more specifically helmets at this point in time before perhaps narrowing further by mens, womens, child or brand. The results are displayed based upon filter 10200 which is currently top sellers but could be cost, availability etc as would be known to one skilled in the art.

Within these are first helmet 10300 being a “Petzl Ecrin Roc Helmet” where they are also shown the price range “$215.00-$235.00” from retailers offering this helmet together with a review rating, in this instance just over 4 stars, and a list of retailers offering the product, namely Mountain Equipment Coop (MEC), SAIL and Petzl. Also displayed is second helmet 10400 being a “Camp Armour Lady Helmet” retailing for between “$79.00-$85.00” from MEC, SAIL and Armour. However, the retailer Armour also indicates that the product is only available within the United States. Accordingly if the giftor wishes to have this product specifically for the giftee, who lives in Canada albeit close to the US border in Windsor and hence adjacent to Detroit, they will need to assign the region as being the US rather than Canada—Ontario. Also presented is an offer 10500 indicating that any gift credit purchased for climbing gear before Sep. 20, 2011 will be discounted to the giftor by 10%, i.e. they pay $90 for a $100 gift credit.

Optionally, offers within the credit gifting system are restricted to being across product categories, such as shown in FIG. 10B, to remove retailer issues with multiple retailers in same product category or may be specific to a retailer or subset of retailers including individual advertisements that are timed in display so that the giftor will see multiple advertisements whilst on a given web page. It would be evident to one skilled in the art that other options exist without departing from the scope of the invention.

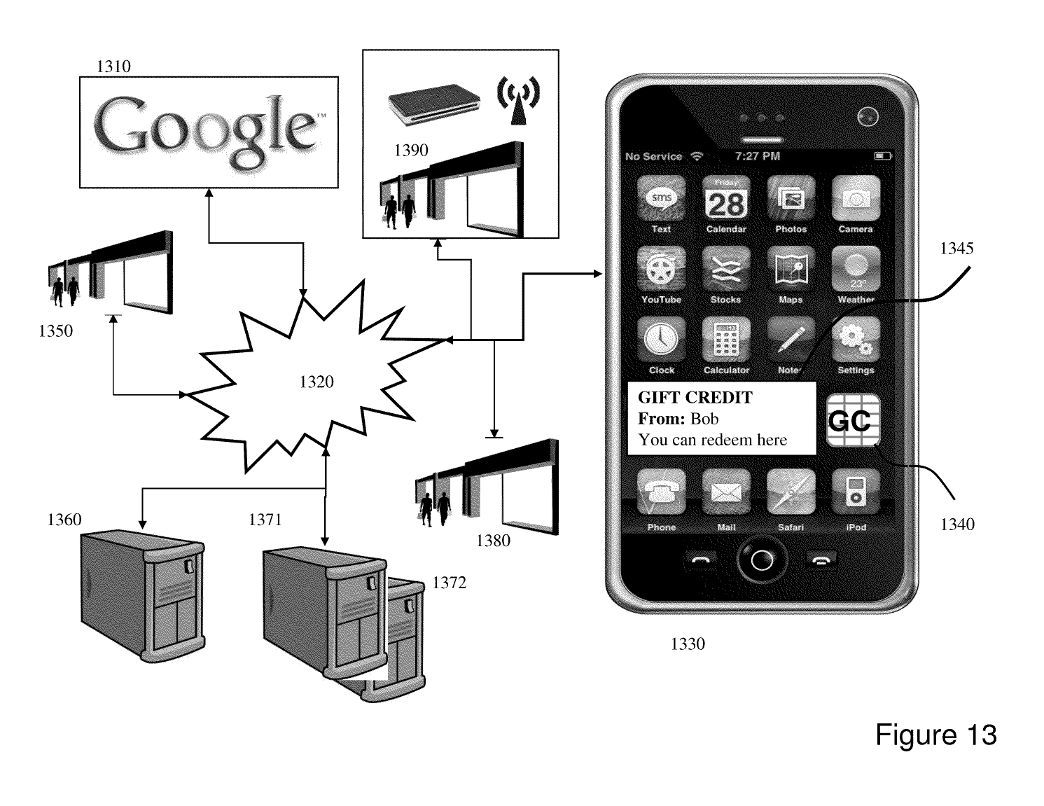

Referring to FIG. 11 there are shown first and second display screens 1100A and 1100B respectively for a credit gifting application according to an embodiment of the invention presenting translation options relating to the giftor and giftee respectively. As discussed above in respect of FIG. 8 a giftee may elect to transfer a gift credit to a third party in another country. Similarly in FIG. 9 a giftor may in registering a giftee have identified their address anywhere in the world and in FIG. 10 have elected to restrict the gift credit to a particular jurisdiction. Where the credit gifting application operates across multiple countries with different languages where a giftor may move freely, e.g. Europe, or within a country with multiple languages, e.g. Canada with English/French, Spanish/English in US, or French, Italian, German in Switzerland, there may be instances wherein the giftor or giftee are accessing information relating to a retailer or retailers.

In some instances the gift credit may relate to a particular jurisdiction or have jurisdictional restrictions. For example, a gift credit allowing the giftee to purchase an entry into a lottery, for example Government operated or charity lotteries, may mean that the giftee cannot purchase if they reside outside a particular geographical region or must be over 18, over 21 etc.

In first display screen 1100 the current location associated with either the giftee or the geographical restriction being applied by the giftor is “Canada—Quebec” wherein the credit gifting application denotes the local language as “French” and the home language of the giftor as “English”. Accordingly, the giftor is asked whether they wish to translate into their language the catalog information that they access in establishing the restrictions for the gift credit when selecting particular products or stores in the series of drop-down dialogs etc in restriction block 1020 in first display screen 1000A in FIG. 10 and catalog screen 1000C in FIG. 10B. Accordingly the giftor can select a translation engine, for example Babylon 9, Yahoo™ BabelFish and Google™, together with “Yes” and “No” buttons wherein subsequent retrievals by the credit gifting application retrieving information from the credit gifting system in the local language are translated to the home language of the giftor. Also displayed in first display screen 1100 are icons allowing the giftor to navigate within the credit gifting application, such as profile, and exit and others linking to social networks and user accessibility.

In second display screen 1200 during a redemption activity by the giftee relating to a gift credit they have received is depicted. As discussed in respect of FIGS. 3 through 10 a giftor may select a gift credit for a giftee that relates to a location the giftee will visit on business or on pleasure. Accordingly, when the giftee accesses the credit gifting application to retrieve information relating to the gift credit such as the catalog of a retailer associated with the location specified by the giftor. As noted in second display screen 1200 the location selected for the gift credit is “Brazil” wherein the local language of content is “Portuguese” whilst the giftee's language is “English.” Accordingly, the giftee is presented with the option of having the content relating to the location, retailers in the location, etc translated via “Yes” and “No” buttons as well as selecting their choice of translation engine, in this example Babylon 9, Yahoo™ BabelFish and Google™.

Optionally, credit gifting application and credit gifting system do not provide the giftee/giftor with a selection of translation engines but default to one determined by the credit gifting system. Similarly, the credit gifting application and credit gifting system may automatically translate any content that is stored within the credit gifting system into the home language of the giftee or giftor. These default languages may be established during the profiles of the giftor/giftee being established or subsequently when the giftee or giftor accesses a profile icon to navigate to the profile section and modifies the setting(s).

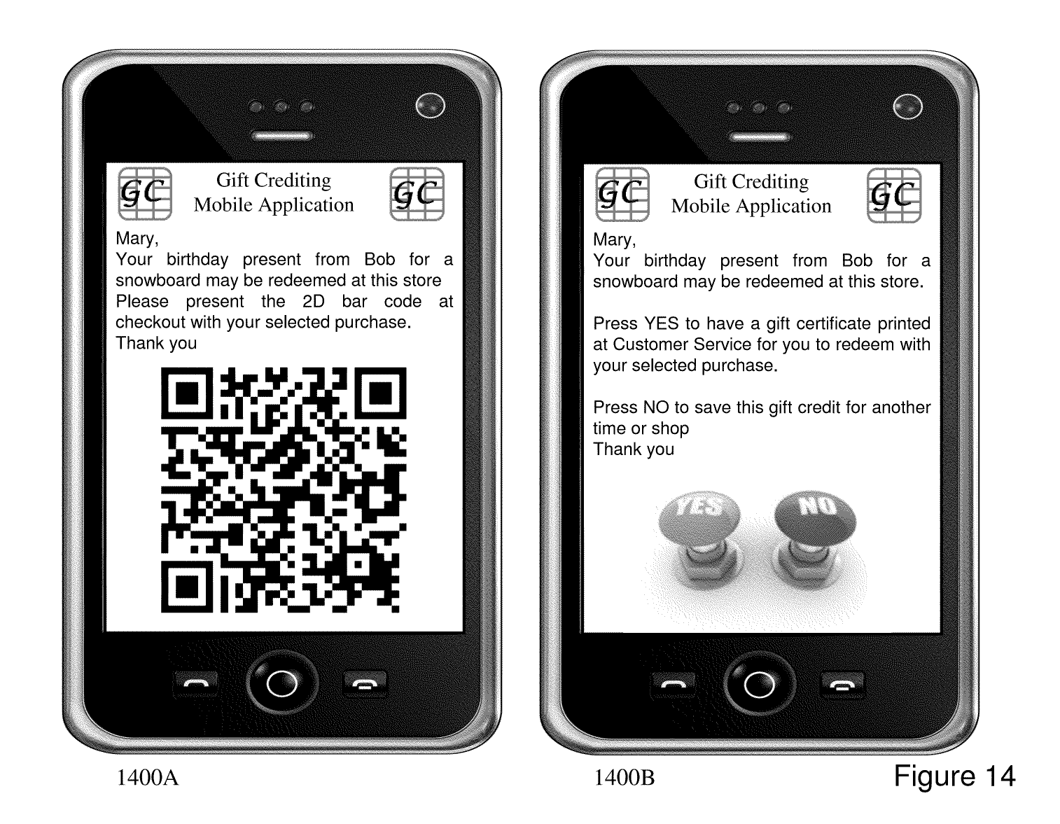

Referring to FIG. 12 there are depicted first to third display screens 1200A through 1200C respectively of a credit gifting application according to embodiments of the invention in respect of notifying a giftee of a gift credit. In first display screen 1200A the giftee is notified via a tweet 1210 posted by “Bob” whom is followed by “Mary” on Twitter™. Alternatively, the post to the social network is made as a notification selected by the giftor to be made in parallel to the main communication to “Mary” by “Bob.” Second display screen 1200B depicts the scenario wherein the notification to the giftee is made by email 1220 and hence appears in their inbox. Third display screen 1200C depicts the scenario wherein the notification is made via the credit gifting application 1230. As discussed above in respect of FIG. 10 the giftor may elect to use one or more notification means as well as sending additional notifications to others.

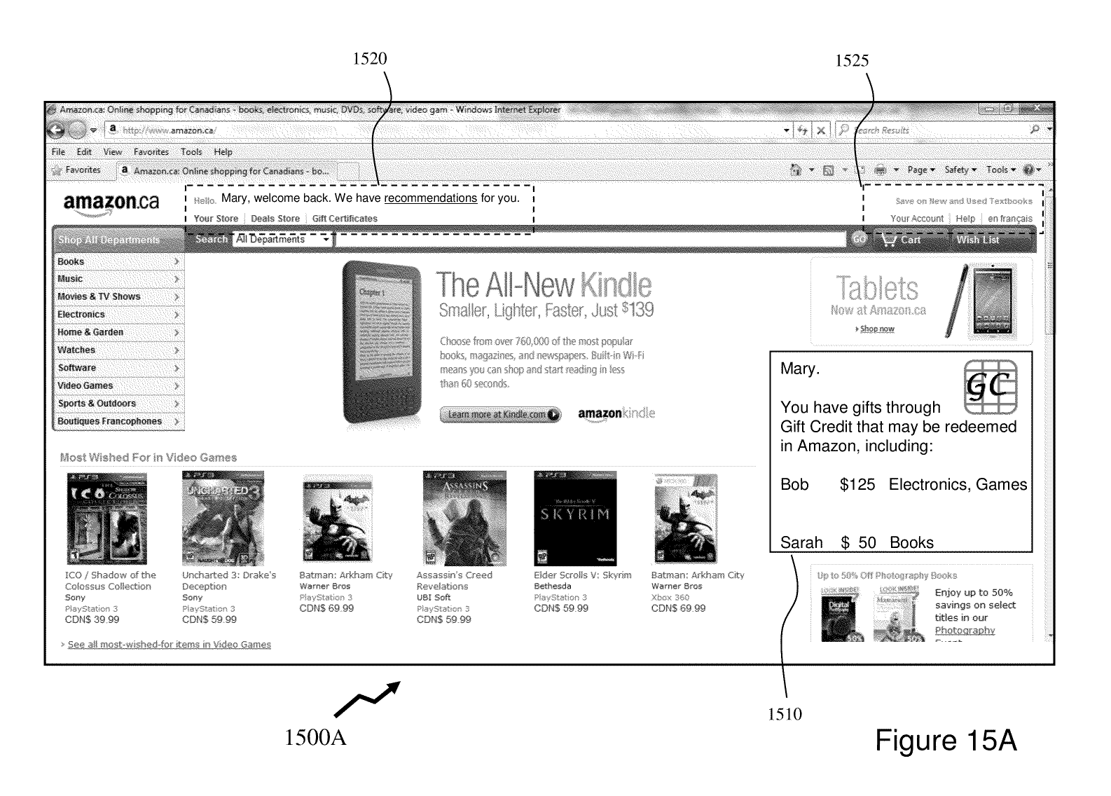

Now referring to FIG. 13 there is shown a system schematic 1300 relating to a credit gifting application according to an embodiment of the invention wherein a giftee receives a gift credit notification with a credit gifting application upon their portable electronic device 1330. The giftee's portable electronic device being connected via a network 1320 to the credit gifting system 1360. Also connected to the network 1320 are first to third retailer servers 1371 to 1373 respectively relating to first to third retail locations 1350, 1380 and 1390 respectively. Accordingly the giftee having received the gift credit from the giftor proceeds to go about their normal activities with the thought in their mind of redeeming the gift credit but not immediately and as a result they move to work, home, shopping etc with their portable electronic device 1330 with them. The credit gifting application 1340 loaded upon their portable electronic device 1330 has stored the gift credit details and accordingly may at times prompt the giftee regarding their gift credit. For example the giftee visits third retail location 1390 and his portable electronic device 1330 communicates to the in-store Wi-Fi thereby identifying the store but also providing direct advertising to the giftee. In this instance the credit gifting application 1340 initiates a prompt 1345 to the giftee that they can redeem the gift credit at this third retail location 1390.

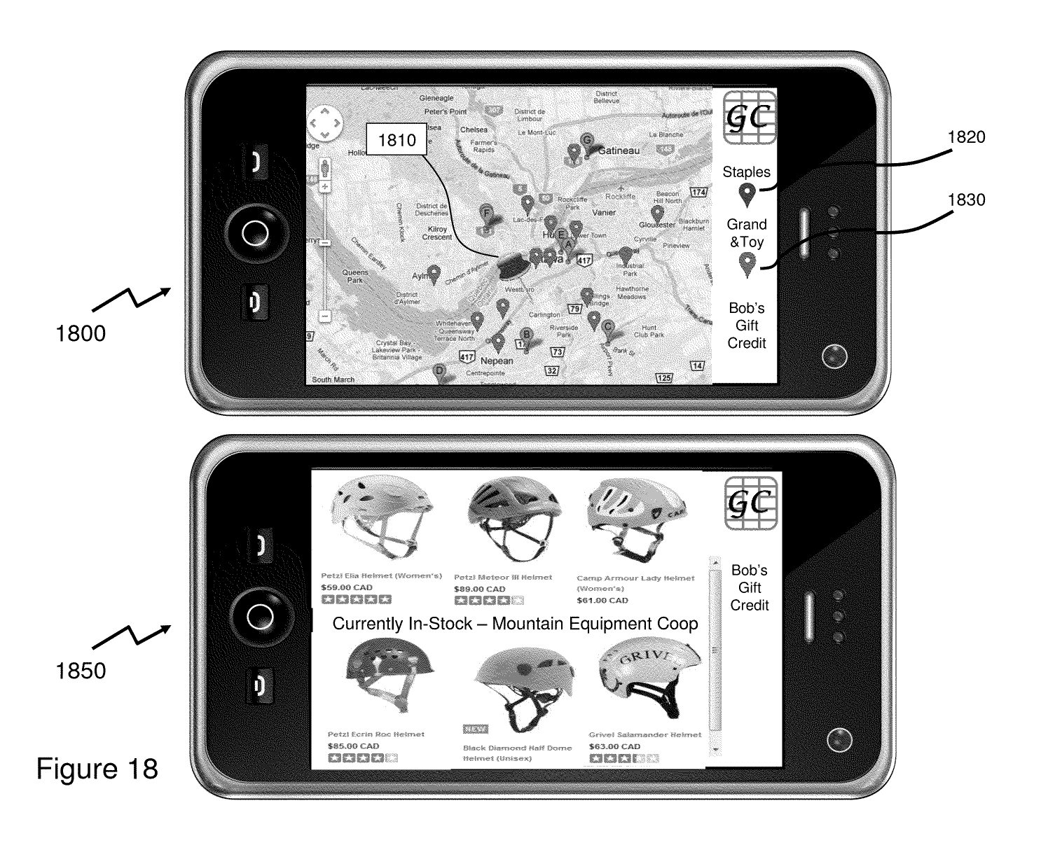

Alternatively, the giftee has had the gift credit for a predetermined period of time that equals the reminder period set by the giftor in establishing the gift credit, such as described above in respect of second display screen 1000B in FIG. 10, but has not redeemed it. In this instance, the credit gifting application 1340 accesses the gift credit details and, if necessary, the credit gifting system 1360 to establish retailers within the local environment of the giftee, to a predetermined distance established by the credit gifting system 1360, and accesses a mapping service 1310, shown as Google™, wherein a display is provided to the giftee with a map indicating the locations of stores they can redeem the gift credit from, such as shown in FIG. 18 by first display screen 1800. Whilst first to third retail locations 1350, 1380 and 1390 respectively provide periodic updates to the credit gifting system 1360 in respect of their retail outlet locations the opening hours of these retail outlets may not be stored within credit gifting system 1360. In this instance the first and second retail locations 1350 and 1380 sit within the predetermined distance whilst third retail location 1390 sits outside the predetermined distance from the giftee's location. Accordingly, the credit gifting application 1330 accesses the first and second retail servers 1371 to 1372 respectively of the retail chains associated with the first and second retail locations 1350 and 1380 respectively, as well as other retail locations identified within a consolidated list of stores retrieved from the credit gifting system 1360, and retrieves their opening hours. The giftee is therefore provided with a map, not shown for clarity, that indicates the region around the giftee to at least the predetermined distance with the stores where the giftee may redeem the gift credit are located with color coding to indicate open and closed stores at that point of time.

Optionally, the color coding of stores that are open or closed may be established at a predetermined time ahead of the time the map is presented to the giftee where that time is determined from the time it would take for the giftee to reach that store as it would be frustrating to the giftee to be told that a store is open from which they may redeem the gift credit only to find the store closed when they reach it having made the decision to go there based upon the map and prompt regarding the gift credit. Alternatively, in the instance that the giftee has multiple gift credits to redeem the map may display the locations of all retail outlets within the predetermined distance that the giftee can redeem the gift credits from individually or in predetermined subsets. Where the giftee may redeem multiple gift credits at the same time in one retail location that location may be highlighted preferentially on the map through well-known features such as highlighting that marker, adjusting the size of that marker, and adjusting the color of the marker. In the event that the results from the retail location search return a large number of results the predetermined distance might be reduced to filter further this list to below a predetermined number of locations in order to avoid a map that is difficult to read due to the large number of markers. Optionally, the giftee may zoom the map in and out wherein the credit gifting application would communicate to the credit gifting system 1360 to retrieve modified lists of retail locations for display and remove the time based display element and only accesses such opening hour information upon the giftee selecting a location on the map.

Now referring to FIG. 14 there are shown first and second display screens 1400A and 1400B of a credit gifting application according to an embodiment of the invention relating to a giftee redeeming a gift credit upon a giftee's portable electronic device. In first display screen 1400A the credit gifting application has determined that a gift credit can be redeemed at the location that the giftee is currently in, for example through the portable electronic device communicating with a Wi-Fi or other local area wireless network of the location, GPS, or base-station triangulation etc. The credit gifting application also identifies either from the local server of the location or from the information stored within the credit gifting system that the location has point-of-sale terminals compatible with 2D bar codes and hence displays to the giftee a message relating to the gift credit and a 2D bar code wherein the giftee presents the 2D bar code for reading at the point-of-sale terminal to redeem the gift credit. The 2D bar code having been generated in dependence upon information relating to the gift credit that was either provided at the initial notification of the gift credit or subsequently, such as for example once the giftee is in the retail location.

In second display screen the credit gifting application has determined that the giftee is similarly in a retail location that they can redeem a gift credit from but that the retail location does not support for example 2D bar codes such as described in respect of first display screen 1400A. Accordingly, in this instance the message to the giftee indicates that they can have a gift certificate printed at Customer Service and is provided with buttons to trigger or cancel this activity. It would be evident to one skilled in the art that the credit gifting application may exploit other methods of providing redemption of the gift credit to the giftee in dependence upon the retail location they are currently in when wishing to redeem the gift credit.

Referring to FIG. 15A there is shown a first display screen 1500A when a giftee accesses a website of a member retailer to gift crediting application according to an embodiment of the invention. In this instance first display screen 1500A representing “amazon.ca” being the “.ca” domain of Amazon™ when the giftee has logged into the website and therefore is identified in the header 1520 of the web page and may access their account details in link block 1525. Also presented is gift credit block 1510 wherein the giftee can see that they have gift credits redeemable from this website, in this instance from “Bob” for “Electronics, Games” and “Sarah” for “Books” and that these are valued at $125 and $50 respectively. If the gift credit from one or other of “Bob” and “Sarah” had been partially redeemed then the values displayed to the giftee would reflect the current outstanding balance.

It would evident to one skilled in the art that where the giftee has also registered with and/or downloaded an application for a coupon or rebate service which periodically distributes special offers, coupons, rebates, etc to registered individuals that the gift credit application and/or gift credit system may associate and/or become networked with these such that where a special offer, coupon, rebate etc aligns with a gift credit for the giftee in terms of the retailer and/or wares/services restrictions set by the giftor that this is identified to the giftee through the gift credit system and/or gift credit application, through the provider of the rebates etc.

In FIG. 15B a second display screen 1500B is shown when a giftee accesses a product page on a website of a member retailer to gift crediting application according to an embodiment of the invention. As shown in product detail block 1530 the price of the “Kindle Wi-Fi, Graphite 6 inch Display” is listed as $139.00 which is higher than the value of the gift credit from “Bob.” Further, the gift credit from “Sarah” cannot be combined with that of “Bob” as they relate to different product areas. However, “Bob” has established an overage on the gift credit resulting in information block 1540 being displayed that indicates to the giftee that the product may in fact be purchased with the gift credit from “Bob.” This may adjust the giftee purchasing decision in some instances wherein they wish to add the minimum of their own funds to redeem the gift credit. Optionally, if the gift credits from “Bob” and “Sarah” had both been applicable to the same product area, category, or specific product, depending upon the particular gift credit settings established by “Bob” and “Sarah” the website may have provided a different notification to the giftee indicating that the selected product could be purchased by combining the two gift credits.

It would be evident, to one skilled in the art, that optionally a giftee may redeem two or more gift credits in association with a single product or group of products where the giftors have provided either overlap of retailers, product categories or product for example. Accordingly, a family or group of friends may club together to provide a large gift to a giftee without the issue of one family member or friend providing all the necessary funds and trying to then collect the contributions of the other family members and/or friends.

Referring to FIG. 15C a third display screen 1500C is shown when a giftee accesses a checkout process on a website of a member retailer to gift crediting application according to an embodiment of the invention. Accordingly, the giftee is presented with multiple options for payment including those in registered card block 1550 where credit cards relating to the giftee that they have previously registered with the website, in this instance “amazon.com” are presented allowing the user to select one of these. Also displayed is credit card block 1560 where the giftee can provide details relating to a different credit card, gift credit block 1570 wherein the giftee can select an available gift credit and apply it against the purchase even if it does not cover the total costs, store card block 1580 wherein the giftee may use a store credit card if they have one, and checking block 1590 wherein the giftee may use a personal checking bank account. Optionally, the order of these options may be varied according to the existence of a gift credit or gift credits so that the user preferentially is directed to redeeming the gift credit(s).

It would be apparent that the process described in respect of FIGS. 15A through 15C for a giftee accessing a website of a member retailer to gift crediting application according to an embodiment of the invention may also apply to the giftee accessing product information within the gift credit application and gift credit system. In this later instance the product offerings provided may be extracted from multiple websites where the gift credit is applicable across multiple retailers depending upon their search terms. In instances that two or more retailers offer the same product then they may all be displayed, they may be filtered according to preferences of the giftee, or they may be filtered based upon previous spending patterns of the giftee for example.

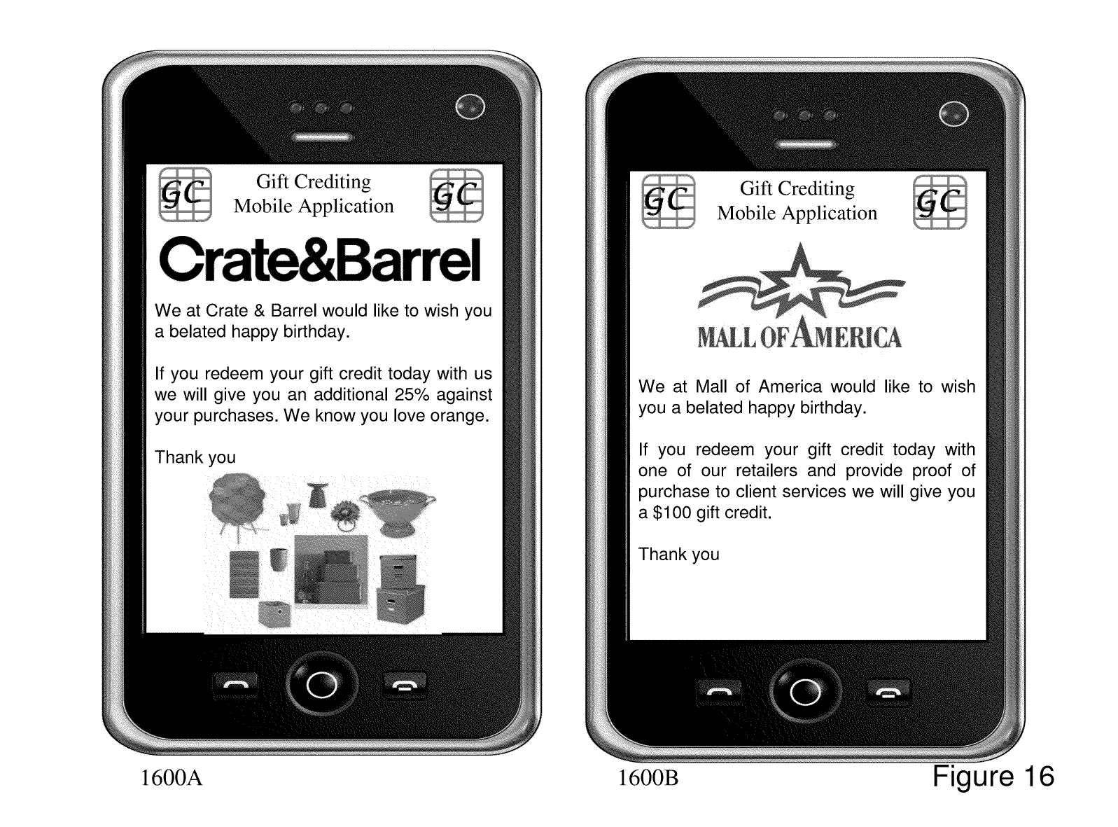

Now referring to FIG. 16 there are shown first and second display screens 1600A and 1600B of a credit gifting application according to an embodiment of the invention wherein a giftee is provided incentives from retailing organizations that are members of the gift crediting application. Considering first display screen 1600A the giftee receives an incentive message from “Crate & Barrel” offering the giftee an additional 25% if they redeem the gift credit today with them. The incentive message may for example be triggered by the giftee being proximate to a “Crate & Barrel” retail location and establishing communication to a Wi-Fi or other wireless network of “Crate & Barrel” or the giftee being within a predetermined distance of “Crate & Barrel” thereby triggering a general incentive message. Such incentive messages may for example be provided in this manner specific to one retail location as the giftee passes them or posted to the credit gifting system by the retailer wherein they are transmitted to those giftees with gift credits that may be redeemed at that retailer and are triggered based upon location information or other predetermined criteria.

Similarly in second display screen 1600B the giftee receives an incentive from “Mall of America” wherein they receive a $100 gift certificate upon providing proof of a purchase being made in the “Mall of America” that day. Accordingly, the “Mall of America” may incent people to shop within itself rather than one of the other malls in the area. Such an incentive program allowing “Mall of America” to increase store on store sales for retailer in that location thereby increasing the retention of high profile retailers and providing financial incentive to other retailers to locate in the “Mall of America.”

It would be evident to one skilled in the art that the giftee may receive advertising/offers from the retailer(s) matching the criteria established by the giftor or where the giftor does not restrict the retailer selection but rather elects to specify a product or product category from those retailers that are member of the gift crediting system that have promotional materials relating to the product or product category. Optionally, these promotional materials may be sent to the giftee such that they are accessed through the gift crediting application or sent by the gift crediting system to the giftee by another means such as for example, an email to an email address of the giftee or a post to a group, account, or forum the giftee follows. These promotions may relate specifically to additional benefits to the giftee redeeming their gift credit or be general promotions that correlate to the gift credit.

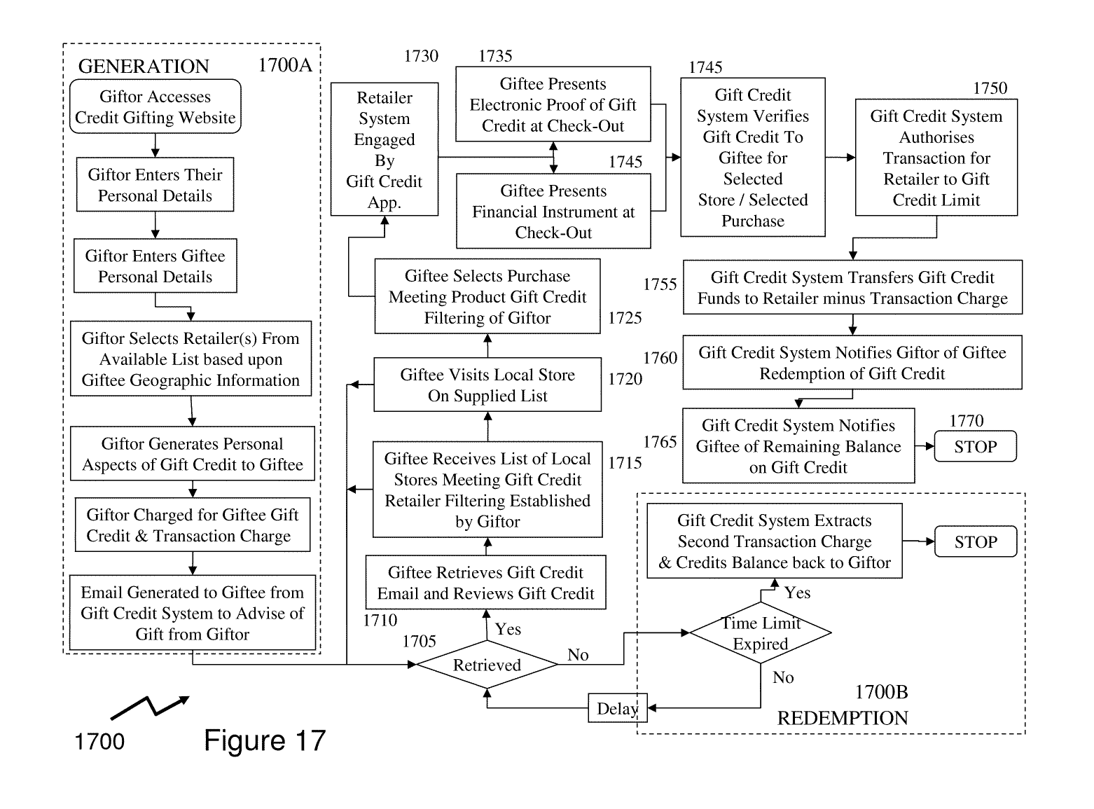

Referring to FIG. 17 there is shown an exemplary flow diagram 1700 according to an embodiment of the invention. Depicted is first process block “Generation” 1700A which represents the process of a giftor accessing the gift crediting system and gifting a gift credit to a giftee. As such first process block “Generation” 1700A is equivalent to process steps 705 to 735 in FIG. 7 above. According a giftor accesses the gift crediting system, either through a webpage or through a gift crediting application as described above in respect of FIGS. 3 through 16, enters their personal details followed by the personal details of the giftee, is presented with a list of retailers based upon the giftee's geographic information and selects the retailer(s) they wish to use for the giftee to redeem their gift at. Optionally, as described above in respect of FIGS. 3 through 16, the giftor may elect to select the gift credit by product category and/or product type either alone or in combination with retailer selection(s). The giftor then generates the personal aspects of the gift credit to the giftee whereupon the process progresses to charging the giftor for the value of the gift credit and a service fee. The giftor having previously given authorization for the gift credit and any applicable service fee to be charged to their financial instrument of choice, e.g. credit card or cash. Finally, the gift crediting system generates an email to the giftee advising them of the gift from the giftor.

From the first process block “Generation” 700 the process moves to step 1705 wherein the gift crediting system checks to see if the gift credit has been retrieved by the giftee. If yes then process moves to step 1710, otherwise the process moves to second process block 1700B, equivalent to process blocks 770 to 785 in FIG. 7 above. As such the gift crediting system checks to see if a predetermined time limit has expired, and if the time limit has not expired the process cycles back to step 1705 otherwise the gift crediting system returns the gift credit to the giftor with a second transaction charge deducted and stops.

In step 1710 the giftee retrieves the gift credit and reviews the retailer's services and/or products gifted to them by the giftor. The giftee receiving the gift credit from the gift crediting system electronically on their portable electronic device via the gift crediting application, such as described above in respect of FIGS. 3 through 16. The process then moves to step 1715 wherein at a later time, for example, the giftee retrieves a list of local retailers meeting the gift credit retailer filtering characteristics established by the giftor. An exemplary display for such a step being described below in respect of FIG. 18 wherein the process can simply loop back to step 1705 if the giftee does not proceed to one of the supplied list of local stores or proceeds to step 1720 if the giftee visits a store on the list as triggered by GPS or ad-hoc association with a local network at the store for example.

In step 1720 the giftee may access on their portable electronic device the inventory selection available to them in respect of that store they are in. This inventory selection may for example be retrieved solely from the gift crediting system by the gift crediting application on the user's portable electronic device, from the store inventory system accessible on the local server at the store through the local ad-hoc network, or a combination of the two. An example of this being also described in respect of FIG. 18 below. If nothing further proceeds after a predetermined time for example or the giftee exists the gift crediting application then the process returns to step 1705. Otherwise it proceeds to step 1725 wherein the user selects a purchase meeting the product gift credit filtering established by the giftor and the process moves to step 1730 wherein the giftee indicates that they have selected an item that meets the product gift credit filtering established by the giftor wherein the retailer system communicates to the gift crediting application such that the gift crediting application on the giftees portable electronic device notifies the giftee as to how to proceed. Additionally at this point the retailer system may communicate with the gift crediting system to verify the gift credit in its entirety or specific aspects thereof such as value, overage policy, etc.

This being indicated for example by proceeding to process step 1740 wherein the giftee is advised to proceed to the check out wherein they present a financial instrument, the retailer system recognizes the giftee and applies the gift credit to the purchase. Alternatively the process proceeds to step 1735 wherein the giftee is advised to proceed to the checkout and the gift credit application proceeds to display a barcode, for example that is scanned at the point-of-sale terminal and the gift credit applied to the transaction. Other options would be evident to one skilled in the art as described above in respect of FIGS. 3 through 16.

Accordingly, from either process steps 1735 or 1740 the process moves to step 1745 wherein the gift crediting system verifies the transaction with the retailer system for the selected store, retailer, product etc and the information provided by the giftee, such as barcode for example, and then proceeds to step 1750 wherein the gift crediting system authorizes the transaction for the retailer's retail systems to the gift credit limit if required, or to the value of the purchase if less than the gift credit value set by the giftor. Next in step 1755 the gift crediting system transfers the funds relating to the gift credit transaction to the retailer's systems minus the transaction charge agreed between the retailer and the gift crediting system provider. This may for example be a fixed fee in some instances or a percentage of the transaction in others. The process then process to step 1760 wherein the gift crediting system notifies the giftor of the giftee redemption of the gift credit and then to step 1765 wherein the giftee is notified of an remaining balance on the gift credit and proceeds to stop in step 1770.

Optionally the gift credit may be established with varying criteria by the giftee as discussed above in respect of FIGS. 3 through 16. For example, as discussed the giftee can establish an overage such that should the selected “gift” purchased may be above the value specified it is allowed to the overage, for example 10%. However, the giftor may whilst allowing the giftee to purchase two or more “gifts” may not wish the giftee to buy additional trivial items to reach the gift credit limit. In this instance the giftor may establish a threshold, for example 80% or 90%, such that if exceeded the gift credit is terminated to the giftee and the remaining balance, adjusted for a transaction fee in some instances, would then be returned to the giftor. In other embodiments, any residual gift credit not utilized is absorbed by the gift credit system provider.

Referring to FIG. 18 there are depicted first and second display screens 1800 and 1850 on a portable electronic device according to an embodiment of the invention. First display screen 1800 presents a map view to a giftee, such as described above in respect of process step 1715 in FIG. 17, with retailers within a predetermined distance of the giftee displayed that meet the criteria established for a gift credit from “Bob.” In this instance the retailers being “Staples” 1820 and “Grand & Toy” 1830 and shown relative to the giftee's current location 1810. The current location being established, for example, by GPS integrated within the portable electronics device.

Second display screen 1850 presents a list of products to a giftee, such as described above in respect of process step 1720 in FIG. 17 wherein climbing helmets are displayed to the giftee wherein these represent products within the giftor established parameters for their gift to the giftee. In the instance that a significant number of products are returned matching the giftor established parameters it would be evident that one or more product sorting and/or menu presentation techniques known in the art may be employed.

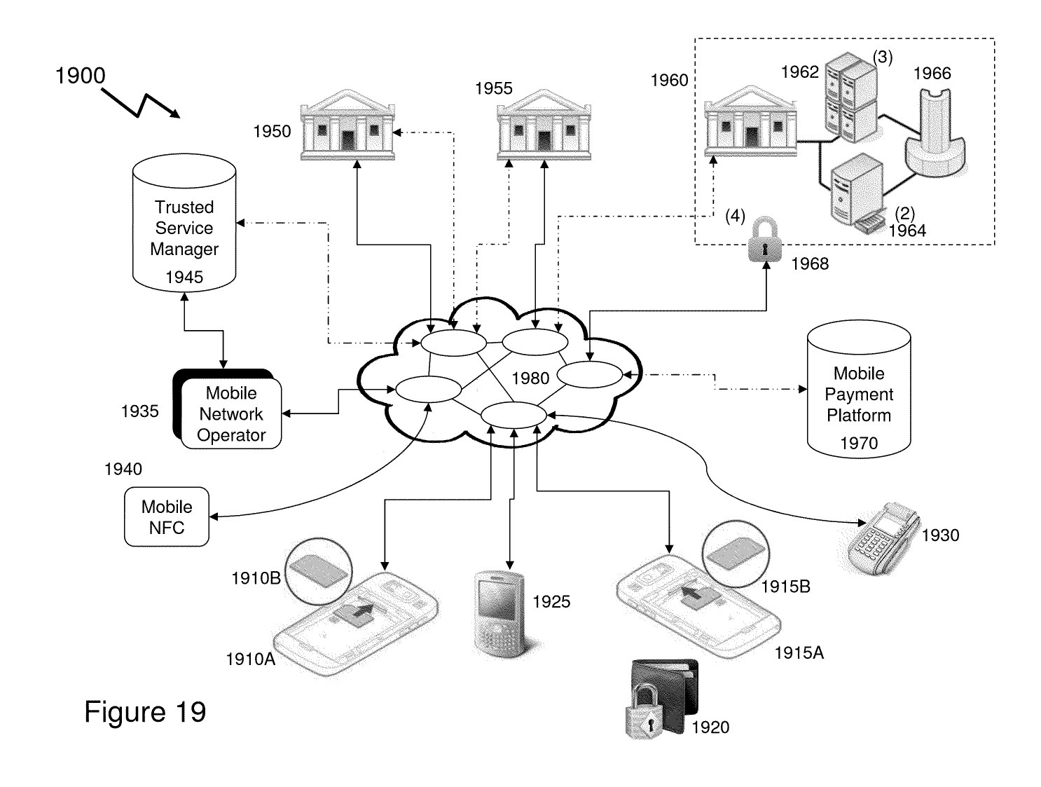

Now referring to FIG. 19 there is depicted a financial system 1900 supporting mobile transactions for a gift crediting application according to an embodiment of the invention. As depicted a first user 1910A has a PED within which they have inserted a merchant provided SIM card 1910B accesses a network 1980 to which are connected first to third financial institutions 1950 through 1960 respectively together with mobile network operator system 1935. Merchant SIM card 1910B may be provided for example by one of the first to third financial institutions 1950 through 1960 respectively, mobile network operator 1935, and a third party merchant including another financial institution or the gift crediting service provider. Also connected to the network 1980 are Trusted Service Manager 1945, mobile near field communication (NFC) system 1940, point-of-sale (POS) terminal 1930 and Mobile Payment Platform 1970. Additionally second user 1925 and third user 1915A are connected to the network 1980. Third user 1915A having a customer SIM card 1915B within their PED together with an electronic wallet application 1920.

Third financial institution 1965 a central server 1966 maintains control over all banking activities and communicates to security server 1964 and application server 1962. Security server 1964 hosts within each data center of the third financial institution 1965 software programs designed to protect the systems and data of the third financial institution 1965 and maintains software programs on all other servers of the third financial institution 1965. Such software programs in execution on the servers include for example firewalls, lockout mechanisms, antivirus protection, system health alerts, and intruder detection. Application server 1962 hosts software programs authenticating that a user, for example third user 1915A or second user 1925, have permission to view the information they are requesting and maintains permissions. Financial communications between the third financial institution 1965 and a user, for example first user 1910A exploit Secure Socket Layer (SSL) connections, for example, to protect all critical information, including for example login, confidential data, transaction data, certificates, security keys etc. are protected and not compromised. Credentials transferred during such a SSL connection are represented by icon 1968.

Accordingly a user, for example third user 1915A, within a store, not shown for clarity, seeks to make a purchase using NFC techniques with POS terminal 1970 wherein information regarding the transaction request, authorization(s), verification(s) and purchase completion are communicated from the PED of the third user 1915A and the POS terminal 1970 to a predetermined subset of the trusted service manager 1945, mobile near field communication (NFC) system 1940, and mobile payment platform 1970 together with one or more of the first to third financial institutions 1950 through 1960 respectively. With third user 1915A additional communications may be made to the electronic wallet application 1920 installed on their PED and data accessed/stored from the consumer SIM card 1915B installed within their PED. In contrast first user 1910A in completing the same transaction has data accessed from the merchant SIM card 1910B installed in their PED. Accordingly, merchant SIM card 1910B may be specific to a financial service, e.g. VISA, MasterCard, PayPal for example, and employ dedicated encryption/decryption or encoding/decoding to that financial service. Optionally, merchant SIM card 1910B may be dedicated to financial services from multiple providers and intended to store said information in isolation from the user's other data which may be stored within a customer SIM card also installed within the PED of the user.

Communications between the wireless PEDs of the users within FIG. 19 may for example exploit the Wireless Application Protocol (WAP) which is an Internet-based global standard that allows mobile devices to interactively access content and applications from the Internet and corporate Intranets. WAP creates an open global environment for wireless applications and is network-, bearer- and manufacturer-independent. WAP arose from the need to find a way to effectively take into account the critical constraints of wireless communications: limited bandwidth, challenging conditions of use, specific graphical user interfaces and the processing characteristics of the mobile phone. The evolution of third-generation (3G) and fourth-generation (4G) mobile networks provide increased bandwidth and the always-on capability of packet-switched networks. Simultaneously, the processing capacity of handsets is developing along with the screen size, and with it the graphical user interface, are becoming more advanced.

Existing WAP specifications exploit security mechanisms to provide secure networks and communications and are based primarily on Public Key Infrastructure (PKI) exploiting certificate-based cryptographic systems with asymmetric algorithms exploiting public/private key pairs associated with each party. Accordingly parties exchange certificates, which are data structures binding the identity of the certificate holder to a public key and are issued by Certification Authorities (CAs) who also ensure their authenticity: Accordingly extension of PKI into the mobile environment, called Wireless PKI, Mobile PKI or WAP PKI, encompasses the infrastructure and the procedures required to enable the trust provisioning needed for authentication and digital signatures for servers and clients. WPKI procedures provide for certificate enrollment and lifecycle management, specifically the certificates' creation, distribution, verification and revocation. The key elements of a typical WAP/WPKI system forming part of the financial transaction system 1900 according to an embodiment of the invention include:
PEDs with WIM (WAP Identity Module in which secure data is stored) support, such as merchant and customer SIM cards 1910B and 1915B respectively in FIG. 19 within the user's PEDs;
WAP Gateways enhanced with certificate-based identity validation capability, such as Mobile Payment Platform 1970 in FIG. 19;
Registration Authority (RA) for certificate enrollment, such as Trusted Service Manager 1945 in FIG. 19; and
Back-end PKI infrastructure with access to Certification Authority (CA) infrastructure, such as Trusted Service Manager 1945 in FIG. 19.

Back-end PKI infrastructure is fairly similar for both the wired and wireless PKI where the primary deviation is certificate enrollment due to the need to accommodate an efficient mass-market rollout. In smart card-based PKI solutions, the issued certificate is linked to a specific user identity through customized enrollment, such as for example, to obtain a government-issued ID chip card one goes to the police station personally with a passport in hand and fills in an application, after which a certificate is issued. Customized enrollment, however, is not suitable for the mobile commerce mass market. In an exemplary wireless PKI solution, anonymous key pairs are pre-installed in WIM cards with a corresponding PIN (Personal Identity Number) code and a manufacturer certificate ensures the keys' authenticity. In the first instance of secure service usage, the Registration Authority (RA) of the WPKI validates the credentials and then requests the CA to create and send a certificate, thus binding the anonymous key pair to a specific user identity. Outlined below is an example of the process:
the registration authority prompts the user with a request form;
the user fills in a form that might request, for example, a user ID and a shared secret such as a one-time password (taken from the existing WAP service agreement);
the user “signs” the response with the private key on the WIM (activated with a PIN code);
the RA validates the proof of possession of the private signature key (POP) and proof of the subscriber's identity (POI);
the RA sends a certificate request to the CA; and
the CA issues the certificate.

The WAP specification on certificate storage allows for different options and the issued certificate can be stored on the WIM card or in a directory upon the user's PED. In addition to user verification and authentication a financial transaction system according to an embodiment of the invention should also address transport security. Within the WAP protocol, transport level security is specified using a protocol known as the Wireless Transport Layer Security (WTLS) which is conceptually and functionally equivalent to Secure Socket Layer (SSL), also known as Transport Layer Security (TLS), the popular security protocol used in the traditional Internet. WTLS invisibly encrypts and decrypts information sent between a WAP client and a WAP gateway to prevent a third party from deciphering the communication between the two. The protocol also ensures the integrity of communications, enabling the recipient of secure information to verify that content has not been altered in transit. According to embodiments of the invention different classifications for WTLS may be employed. A default level WTLS Class 1 allows for an anonymous, secure channel between the WAP client and WAP server; WTLS Class 2 includes Class 1 features plus server authentication, and WTLS Class 3 includes Class 2 features plus client authentication. WTLS Class 3 also supports mutual authentication between the server and consumer by an exchange of certificates. For example the respective partner validates the certificate, for example against the corresponding root CA certificate. A WTLS Class 3 session is initiated only if both checks are positive, otherwise the process is cancelled. Typically a WAP/WPKI system is based on WTLS Class 3.

Storage of the customer side security information is within a WIM, also known as a WAP Identity Module or Wireless Identity Module, within the user's PED and stores all security information such as keys and certificates are stored but may also provide an ability to perform cryptographic operations. The WIM is typically a separate tamper-resistant hardware device, such as but not limited to a smart card or a SIM card such as merchant and customer SIM cards 1910B and 1915 respectively in FIG. 19 which are known as Subscriber Wireless Identity Modules (SWIMs). The WIM may also be a removable part of the terminal hardware which is applicable in mobile network devices that do not use SIM card slots.

In one SWIM solution, WIM functionality is stored on the operator-issued Subscriber Identity Module (SIM) card. The mobile network subscription functionality is however separated from other applications that require authentication and signature capabilities. Standardized features and interfaces are used to ensure interoperability between different manufacturers' technologies and different operators SIM cards. In contrast a Dual Chip approach, wherein a second separate SIM-sized smart card is placed semi-permanently in the PED may provide increased benefit and flexibility. For example, it may be removable and issued independently of the SIM card, for example by a mobile commerce service provider. Beneficially it separates the network subscription, held on the other SIM card. Alternatively another Dual Slot implementation utilizes credit cards of standard size that are inserted into an integrated smart card reader in the terminal whenever a transaction occurs. The advantage is that the same card can be used for multiple channels but now the consumer needs two different device which also presents the integrated reader with challenges on the physical size of the terminal as a key criterion for consumers when they purchase a PED is typically size. In the External Reader solution a separate device with a smart card reader is connected to the mobile terminal by a wire, infrared beam, Bluetooth, or another NFC solution allowing a variety of smart card implementations with varying providers, security, etc for example.

Irrespective of the SWIM solution adopted a digital signature is required to fulfill the criterion of non-repudiation and is the element that replaces the need for visual verifications of ID cards, handwritten signatures, paper receipts, etc. Digital signature technology can fulfill the requirements of authentication and non-repudiation, key conditions in establishing the merits for legally binding commercial transactions. The digital signature, where executed in the WAP application security layer is based on the WML Script Crypto Library. Digital signatures and WTLS Class 3 both share the basic mechanisms for certificate validation and the determination of the trustworthiness of a CA organization. These verification functions enable parties to make decisions regarding the acceptance of digital transactions. It would be apparent to one skilled in the art that other techniques may be employed without departing from the scope of the invention. Accordingly encryption/decryption techniques, access protocols, certificates, key systems etc may all be varied according to one or more prior art approaches as well as proprietary techniques. For example, the financial security systems for the gift crediting application upon a user's PED or FED may be unique to that application and the gift crediting software/service provider or may be common to that service provider's financial systems, such as for example where they are provided by a financial service provider such as MasterCard, Visa, PayPal etc for example rather than by a merchant service provider such as WalMart, Sears, etc for example.

It would be apparent to one skilled in the art that variants of the above described embodiments can be considered that do not depart from the spirit of the invention nor change the object of the invention. Within the embodiments described supra there has been outlined a method and system related to “virtual” gift giving by a third party (the giftor such as giftor 510 in FIG. 5 or giftor 610 in FIG. 6 for example) who purchases a “gift credit” for a gift in lieu of the gift itself for another (the giftee such as giftee 560 in FIG. 5 and giftee 690 in FIG. 6 for example). The gift credit purchase may be made electronically by methods including but not limited to credit card, debit card, electronic funds transfer, and PayPal™. This method of gift giving may be specifically described as a “credit gifting” or “gift crediting” method based upon a system provided by a gift credit provider through a computer network, such as the Internet for example. Credit gifting is the transaction that occurs when one party (‘grantor’) electronically purchases a ‘virtual’ gift in the form of a monetary credit to be used by the second party (“giftee”) to buy a Gift which is obtained from a retailer forming part of the approved retailer list of the credit gifting system and may be redeemed for either a service or product.

Within the embodiments described supra it may be assumed by one reading the descriptions in respect of FIGS. 3 through 17 that the transaction is executed in a single currency. However, the credit purchased can be issued in any currency or denomination for use by the second party (“giftee”) which would be determined by the credit gifting system in dependence upon factors such as the geographic location of the giftee and the geographic location of the retailer store or retailer chain selected by the giftor/giftee. The giftor would be debited in their local currency determined for example upon factors such as their geographic location and the financial instrument employed in the gift credit purchase. It would be apparent to one skilled in the art that some retailers are global in their enterprises and that where these are “smart” as discussed supra in allowing the gift credit to be processed at the point of sale without prior engagement with the giftee, then the transaction may be determined in currency of transaction at that instant of the point of sale, for example a gift credit for Tommy Hilfiger™ might be redeemed as easily in Tokyo or Paris as New York, Los Angeles and Ottawa, and converted by the credit gifting system to a base currency for comparison to the gift credit and appropriate decisions made therefrom.

The gift credit transaction is handled through an enterprise (hereinafter “Company”) which may be part of an existing financial or retail organization or a discrete entity and provides the credit gifting system to consumers and retailers through online portals and the Company web site for example. For example retailers and existing registered giftors may exploit different online portals to the general Company web site. The specific software system application developed to purchase a credit for a gift is called a “credit gifting system” whereby the “credit gifting system” provides a secure electronic commerce environment allowing the giftor to authorize the credit gifting system to use the grantor's credit, debit card, or other monetary credit form to reserve essentially a “gift credit” in favor of a named “recipient” (giftee) with the identified retailer which may be further defined to a particular store within the chain of the retailer or the stores with a geographic region around the giftor's geographic location for example. Alternatively, the giftee can provide the gift for a location not associated with the giftor, such as a planned vacation or business destination.

Furthermore, the grantor (giftor) authorizes the Company to use the grantors credit card, debit card, banks/financial institutions etc to automatically deduct an agreed to “convenience fee/service fee” payable to the Company for the grantors use of the “credit gifting system” and the flexibility, personalization, etc it provides compared with “captive” traditional gift cards or other pre-paid traditional gift cards.

Whereas the Company charges the ‘gift grantor’ a convenience fee for use of the electronic commerce based credit gifting system; all retailers/providers accepted as official Company Retail Merchants, whose ware/service/location data is accessible within the gift crediting application and/or gift crediting system are also automatically charged a “service charge/service fee” when either the gift credit is transferred financially into their systems or the giftor redeems the gift credit. This retailer fee being associated with the retailer being listed as an approved retailer allowing a “grantor” to select them and also in respect of providing them associated with the gift credit processed additional demographic/personal information so that the retailer may improve their indirect and direct marketing activities. Optionally this service fee may be tiered according to whether the gift recipient (giftee) receives notification of the gift credit from the giftor, Company, or the retailer. The Company may also support multiple portals, including for example “GiftCredit.com”, “CreditGifting.com”, “GiftCredit.ca”, “GiftCredit.mobi”, and “GiftCredit.org”, so that retailers have additional information such as whether these purchases are being made by individuals on the home computer, by individuals on their mobile devices, by organizations (i.e. employee rewards), etc. As outlined supra in respect of FIG. 9 the credit gifting system application may also be used by individuals or corporations to electronically purchase a charity ticket or optionally make a donation to a charity.

As presented supra the giftor accesses the credit gifting system web site; reviews the Company provided list of merchants and merchant products and services. Grantor then authorizes the Company to use grantor credit or debit card to securely purchase a “gift credit” on behalf of the giftor for the named recipient from anywhere in the world, at any time of day; in an currency or monetary denomination. The credit gifting system may be accessed using one or more forms of communication including the Internet, LAN, WAN, etc through wireless, coaxial cable, or wired services through a plurality of service provides from a variety of user devices including but not limited to iPod, iPad, cellular telephones, telephones, personal computers, gaming consoles, personal digital assistants, notebook computers, tablet PCs, sales kiosks, etc. Access to the credit gifting system may be directly through the credit gifting system or by applications embedded into either electronic equipment such as mobile devices for example or applications such as social media including but not limited to Facebook™, Twitter and LinkedIn™. Equally the credit gifting system may be added as an element within a web browser such as and not limited to Google™ or Yahoo™ for example.

The embedding of the credit gifting system method into such software, applications, and browsers allows for example the giftor when browsing to rapidly select an item and rather than searching as to where to obtain it simply link through the credit gifting system interface and the knowledge base of the web browser provider to select the retailer automatically and then proceed to sending the gift credit to the giftee. Further whilst the embodiments presented supra have been presented with the user redeeming the gift credit for an item they select from a retailer identified by the giftor it may be evident to one skilled in the art that the system can be made more specific to limiting the gift credit to a particular form of wares, such as kitchenware, sports equipment, clothing etc, be limited to a manufacturer, e.g. Nike™, Burberry™ KitchenAid™, a particular product, e.g. a tennis racket, a coat, a saucepan, or a specific item, e.g. Burberry washed leather jacket, Nike AW77 jacket, All Clad Cop•R•Chef allowing the giftee to select their size without embarrassment etc as the giftee does not need to know the giftor's current personal physical dimensions etc.

It would be apparent to one skilled in the art that the crediting gifting system as proposed may also be provided at free standing or portable electronic kiosks which for example may be placed at shopping malls, within department stores, retail stores, catalog shops etc. It would also be apparent that the credit gifting system approach may form the basis of a gift registry for a wedding, wedding anniversary, birthday etc. In this the giftee may enter the credit gifting system and create a list of desired items, e.g. bakeware, bed linens, cutlery etc and send those invited to attend the event a link to the credit gifting system repository. Then a giftor in logging into the credit gifting system and entering the giftee's details would be directed to a list of items the giftee would like to receive and there from the giftor may select the retail chain, store etc at which a gift credit for the giftee is provided. In this manner a bridal registry for example does not have to be limited to one store providing all the items but is now hosted essentially through the credit gifting system.

In addition to the features and functions described above in respect of FIGS. 3 through 17 it would be evident to one skilled in the art that the financial aspects of the transaction may include, but not be limited to, currency conversion, applying state/national international/country and provincial taxes, and insurance.

It would also be apparent to one skilled in the art that where the gift credit is delivered to a giftee through a format geared to mobile devices, e.g. text, or that the user is accessing the gift credit through a mobile device that the retailer information may be dynamically allocated based upon the location of the giftee at that point. In this manner for example, a giftor may gift a giftee a present on their birthday and the giftee may redeem this based upon their current location rather than their home address as provided to the credit gifting system by the giftee. Additionally it would be evident that where the gift credit relates to a plurality of retail locations and a plurality of retailers that the process may be extended to provide a selection feature wherein the credit gifting system is notified of the location of the giftee, associates that with a particular retailer and/or retail location and transmits to the giftee and/or retailer a second notification that is modified to be compatible with the systems of the retailer selected.

It would also be apparent to one skilled in the art that the gift credit may be redeemed electronically by the giftee rather than them physically visiting a retailer location etc. For example if the gift credit was provided for an online retailer such as Amazon® the giftee may for example enter a unique identifier provided within the message from the giftor or credit gifting system into the online purchasing system of the online retailer through either a field such as “Promotion Code” which many online purchasing portals have as a standard feature or through entering this unique identifier in another field of the online form for purchasing. The retailer e-commerce system would then recognize this unique identifier as referring to a credit existing with the retailer through the credit gifting system. Equally the giftee may elect to order from the online purchasing system provided by the retailer that the giftor selected for a variety of reasons including ease of purchasing without visiting the store, delivery of the purchased items, and online pricing being lower than that in the retail outlet. Accordingly the gift credit may not only be provided electronically to the giftee but may be redeemed electronically by the giftee. It is anticipated that the Company would execute sales representation agreements with every participating merchant. The Merchant acknowledges that the Company has the right to advertise wares/services etc relating to the merchant and charge the merchant multiple fees, for example a yearly fee as a ‘listing’ fee payable for Merchant/Retailer's representation on the Company web site, and additional fees for acknowledging the payment of a mutually agreed upon service charge for each fully transacted purchase of ‘store’ credit at the time grantor credit/debit card is processed. It would be apparent that some fees may be fixed and others variable in dependence upon the value of transactions or an accumulated revenue stream within that year. The Company further anticipates directly connecting the Company web site to that of the Merchant's allowing selection of retail outlets, merchandise, services etc.

It would also be anticipated, and apparent to one skilled in the art, that the gift crediting system would be interfaced to the Merchant's financial systems so that redemption of the gift credit as recognized and processed by the Merchant's financial systems is communicated to the gift credit system allowing the process to be completed and closed. Such closure for example including notification to the giftor that the gift credit has been redeemed, clearing the pending transaction from the gift credit system, and updating giftor and/or giftee profiles.

Whilst the particular embodiments described supra in respect of the credit gifting system have been presented and discussed in respect of retailers and giftors purchasing through financial transactions. However, it would be apparent to one skilled in the art that major banks or financial institutions, such as MasterCard®, Capital One®, Chase Manhattan, HSBC Bank for example, may issue financial cards that allows the card user to acquire points, much like they would with AirMiles®, which are then redeemable through the credit gifting system for the purchase of gifts or alternatively gifts purchased within the credit gifting system trigger points accumulation in other programs such as AirMiles®.

It would also be apparent to one skilled in the art that the organization managing the gift crediting system may establish its own instruments including but not limited to a credit card or a loyalty card. The loyalty card for example providing a discount or bonus when the giftor has used it a number of times exceeding a predetermined threshold or value of gifts. The discount/bonus being offered for example in escalating manner with increasing usage thresholds. The credit card may for example be a card branded for the gift crediting system organization by a credit provider such as MBNA®, MasterCard® or through a bank such as Bank of America, HSBC, etc. Optionally, the giftor to reward his loyalty with the gift crediting system may be rewarded a cash incentive, such as for example a reduction to the regular convenience fee charged by gift crediting system when making a gift credit purchase.

It would also be anticipated that the giftor using the credit gifting system would have rewards associated with at least one of the financial instrument that they use to pay for the gift credit to the giftee or rewards associated with either another program. Examples of other programs may be those run by their bank, credit card provider, independent programs such as AirMiles®, and even the retailer they are selecting to purchase the gift credit with and with whom they have an account collecting reward points. Whilst these programs may use different terms for the rewards or bonuses given within this specification for simplicity we will refer to them as “reward points”.

In the situation that the giftor has an account with the retailer then they may earn additional reward points from this purchase or elect to transfer reward points given by the credit gifting system to their account with the retailer. Equally the giftor may elect to redeem reward points with the retailer as a way of increasing the gift credit value or reducing their immediate expenditure in purchasing the gift credit. In another situation the giftor may elect to donate reward points, for example those resulting from the gift credit purchase or a portion of others that they have to a charity as part of the overall process they engage in the purchasing of the gift credit. Likewise a giftee in accessing the credit gifting system to redeem a gift credit may be similarly invited to donate reward points to a charity or charities. Similarly a giftee wherein they have the option of selecting to redeem the gift from multiple retailers may be incented by one or more of these retailers with the offer of reward points to the giftee and/or the giftor or a charity.

Retailers who are members of the gift crediting system and/or the gift crediting system may wish to reward a giftor for their use of the gift crediting system. Such a reward for example being a reduction in the service fee charged or a gift credit of their own. Optionally the value of the gift credit/level of reduction in these instances may change according to the usage by the giftor, for example overall in terms of value or within a predetermined period of time. Within the above described embodiments of the invention presented in respect of FIGS. 3 to 18 reference has been made to the giftee obtaining from a retailer a traditional gift card in respect of their gift credit from the giftor. It would be evident to one skilled in the art that alternatively the gift credit from the giftor may be “loaded” onto a traditional gift card already possessed by the giftee. This traditional gift card, for example, being one relating to a specific retailer wherein the gift credit is restricted to one retailer, one relating to a group of retailers wherein the gift credit is restricted to one or more retailers of the group of retailers, or one relating to the credit gifting system and accepted by all retailers that are members of the gift crediting system. Such traditional gift cards including, but not limited to, those with magnetic stripes, electronic circuits, supporting near-field communications, RFID, and other financial instruments as well as the traditional gift card.

Within the above described embodiments of the invention presented in respect of FIGS. 3 to 18 reference has been made to a retailer or retailers the giftor and/or giftee can select during the purchase and/or redemption of the gift credit. Within these embodiments these retailers have been generally described as being online retailers and/or those with retail outlets, i.e. physical locations that are relatively stable in terms of time that they exist, for example a retailer in a shopping precinct, shopping mall, residential neighbourhood etc. However, a retailer may be a member of the gift crediting system without a fixed physical location but engage the giftee in a physical transaction. For example, the giftee may visit a craft fair, art exhibition, or other event that is being held indoors and/or outdoors wherein a retailer has joined the gift crediting system and displays this fact on their booth, stall or retail presence. In these instances the retailer may exploit a point-of-sale including, but not limited to, one interfacing with a portable electronic device, such as for example Square, for swiping a magnetic card, reading an electronic circuit or microchip, or employing wireless and/or near-field communications. Such point-of-sale options also be those that retailers with physical locations and/or online presence.

It would also be apparent to one skilled in the art that whilst the above embodiments have been presented in respect of a gift credit system wherein the giftor is able to select one retailer, multiple retailers, or all retailers registered with the gift crediting system it would be apparent that in other embodiments of the invention the system is “closed” in that an embodiment of the system is provided for, or by, a single retailer thereby allowing the retailer to provide what may be referred to as an electronic, online, or virtual gift card to customers. Optionally, the retailer may be an operator of a shopping mall or malls for example so that for example a gift credit can be purchased for “Mall of America.” Equally, in the options for the giftor when restricting the gift credit an option may be to a particular mall, such as “Mall of America” for example so that, for example, the gift credit is valid with any retailer in the mall or all retailers selling womens clothing. It would also be evident that the gift crediting system when a gift credit is purchased for a giftor by a giftee allows for the message sent to have associated with it or as part of it an electronic card, such as for example a birthday card, anniversary card, according to the selection of an event associated with the gift credit by the giftor during establishment of the gift credit.

It would also be apparent to one skilled in the art that a gift credit established by a giftor to a giftee may be established as a repeating event rather than a one off event such as described above in respect of FIGS. 3 to 18 without departing from the scope of the invention. Optionally, the gift credit system in accessing social networks associated with giftees may in dependence upon the information retrieved therefrom together with the information provided by the giftor populate fields within a calendar/reminder feature such that the giftor is subsequently reminded of impending birthdays, anniversaries, and other events. Optionally, the gift crediting system may when the giftee registers with the service and identifies their electronic mail address(es) and social network(s) the system may prompt for permission to access these and extract calendar information currently accessible within these to create a calendar for the giftee rather than requiring them to enter all dates discretely thereby allowing the registered user to be prompted once they are registered of upcoming events, anniversaries, birthdays, etc.

Within the description of embodiments of the invention above in respect of FIGS. 3 through 18 the giftor is described as accessing the gift crediting system. It would be evident to one skilled in the art that the giftor may access the gift crediting system from a variety of devices including portable and non-portable electronic devices. Optionally the giftor may employ the gift crediting application for their registration, gift selection, etc as described in the embodiments of the invention. Likewise, the giftee may optionally access the gift crediting system from a non-portable electronic device in some instances as well as from their portable electronic device(s). Non-portable electronic devices include, but are not limited to, personal computers, gaming consoles, Internet enabled televisions, and Internet enabled displays. Portable electronic devices include, but are not limited to, cellular telephones, smart telephones, personal digital assistants, multimedia players, laptop computers, tablet computers, and gaming devices.

It would also be evident to one skilled in the art that the gift crediting application, as described above in respect of FIGS. 3 through 18, may be provided on a portable electronic device when acquired by a user or downloaded from a website by the giftor, for example. The gift crediting application may be downloaded, for example, by the giftor in response to receiving a communication indicating the existence of a gift credit, in response to an advertisement, or to send a gift credit themselves. Alternatively, the gift credit application may be automatically transferred to the giftor's portable electronic device based upon indication that a gift credit exists in their name and that they are not currently registered with the gift crediting system.

Within the above embodiments of the invention as described in respect of FIGS. 3 through 18 above the gift credit provided to the giftee by the giftor has been generally described in respect of goods, products, or wares obtained from physical or online retailers. However, it would be evident that the gift credit may relate to a service provided by a retailer wherein the service is provided to the giftee in dependence upon the particular characteristics of the service and the retailer. Similarly, the ware, product purchased may provided to the giftee by way of alternative means including, but not limited to, a hotel reservation, a vehicle reservation, a recreational activity, a sports activity, cable service, telephony service, utility service, and a vacation. Alternatively, the gift credit may be redeemed for cash by the giftor at a location or locations meeting the criteria set by the giftor. In this instance, the giftor may give the giftee a gift credit that could be redeemed at a predetermined bank or banks within a predetermined location for example.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
storing in a non-transitory tangible computer readable medium of a first computer system connected to a first network data a software application encoding a computer process for execution by a processor of a portable electronic device, the computer process comprising:
receiving from a second computer system a first electronic message to the portable electronic device associated with a first user first data comprising a first data portion relating to an aspect of a second user, a second data portion relating to a first financial transaction executed by the second user on a second computer system providing a credit for the first user, and a third data portion relating to a unique first user credential to access the computer system;
transmitting from the portable electronic to the second computer system a second electronic message, the second electronic message being generated in dependence upon at least the unique first user credential;
receiving from the second system a second electronic message comprising a fourth data portion relating to the credit for the first user; and
displaying to the first user in dependence upon an aspect of the portable electronic device information derived from the fourth data portion in relation to the credit.

2. The method according to claim 1 wherein,
the software application is transferred to the portable electronic device in response to a third electronic message received by the first computer system from the second computer system, the third electronic message being generated upon the second computer system determining that the first user to whom the credit relates is not registered with the second computer system.

3. The method according to claim 1 wherein,
the aspect of the portable electronic device is at least one of a current location of the portable electronic device, a location associated with the first user established by the first user, a location associated with the first user established by the second user, and an association of the portable electronic device with a second network.

4. The method according to claim 1 wherein the software application further comprises;
associating the portable electronic device to a second network comprising a server;
retrieving from the server data relating to the credit; and
displaying the data retrieved to the first user.

5. The method according to claim 1 wherein the software application further comprises;
communicating the information derived from the fourth data portion to a third computer as part of a second financial transaction relating to at least one of a ware and service associated with the credit.

6. One or more non-transitory tangible computer readable media encoding a computer process for execution by a processor of a portable electronic device, the computer process comprising:
receiving from a first computer system a first electronic message to the portable electronic device associated with a first user first data comprising a first data portion relating to an aspect of a second user, a second data portion relating to a first financial transaction executed by the second user on a second computer system providing a credit for the first user, and a third data portion relating to a unique first user credential to access the computer system;
transmitting from the portable electronic to the first computer system a second electronic message, the second electronic message being generated in dependence upon at least the unique first user credential;
receiving from the first system a second electronic message comprising a fourth data portion relating to the credit for the first user; and
displaying to the first user in dependence upon an aspect of the portable electronic device information derived from the fourth data portion in relation to the credit.

7. The one or more non-transitory tangible computer readable media according to claim 6 encoding a computer process for execution by a processor of a portable electronic device, wherein,
the aspect of the portable electronic device is at least one of a current location of the portable electronic device, a location associated with the first user established by the first user, a location associated with the first user established by the second user, and an association of the portable electronic device with a network.

8. The one or more non-transitory tangible computer readable media according to claim 6 encoding a computer process for execution by a processor of a portable electronic device, the computer process further comprising;
associating the portable electronic device to a network comprising a server;
retrieving from the server data relating to the credit; and
displaying the data retrieved to the first user.

9. The one or more non-transitory tangible computer readable media according to claim 6 encoding a computer process for execution by a processor of a portable electronic device, the computer process further comprising;
communicating the information derived from the fourth data portion to a second computer system as part of a second financial transaction relating to at least one of a ware and service associated with the credit.

10. The one or more non-transitory tangible computer readable media according to claim 6 encoding a computer process for execution by a processor of a portable electronic device, the computer process further comprising;
establishing communications between the portable electronic device and a second computer system according to a communications standard supported by the portable electronic device;
receiving information from the second computer system in dependence upon an aspect of the credit.

11. The one or more non-transitory tangible computer readable media according to claim 10 encoding a computer process for execution by a processor of a portable electronic device, wherein,
receiving information from the second computer system comprises at least one:
communicating a third electronic message from the portable electronic device to the second computer system to establish an association of the portable electronic device to the credit, the third electronic message generated in dependence upon the third data portion relating to a unique first user credential; and
identifying an aspect of the portable electronic device against information stored on at least one of the second computer system, the first computer system, and a third computer system in communication with the second computer system.

12. A device comprising:
a microprocessor; and
one or more non-transitory tangible computer readable media encoding a computer process for execution by the processor of a portable electronic device, the computer process comprising:
receiving from a first computer system a first electronic message to the portable electronic device associated with a first user first data comprising a first data portion relating to an aspect of a second user, a second data portion relating to a first financial transaction executed by the second user on a second computer system providing a credit for the first user, and a third data portion relating to a unique first user credential to access the computer system;
transmitting from the portable electronic to the first computer system a second electronic message, the second electronic message being generated in dependence upon at least the unique first user credential;
receiving from the first system a second electronic message comprising a fourth data portion relating to the credit for the first user; and
displaying to the first user in dependence upon an aspect of the portable electronic device information derived from the fourth data portion in relation to the credit.

13. The one or more non-transitory tangible computer readable media according to claim 12 encoding a computer process for execution by a processor of a portable electronic device, wherein,
the aspect of the portable electronic device is at least one of a current location of the portable electronic device, a location associated with the first user established by the first user, a location associated with the first user established by the second user, and an association of the portable electronic device with a network.

14. The one or more non-transitory tangible computer readable media according to claim 12 encoding a computer process for execution by a processor of a portable electronic device, the computer process further comprising;
associating the portable electronic device to a network comprising a server;
retrieving from the server data relating to the credit; and
displaying the data retrieved to the first user.

15. The one or more non-transitory tangible computer readable media according to claim 12 encoding a computer process for execution by a processor of a portable electronic device, the computer process further comprising;
communicating the information derived from the fourth data portion to a second computer system as part of a second financial transaction relating to at least one of a ware and service associated with the credit.

16. The one or more non-transitory tangible computer readable media according to claim 12 encoding a computer process for execution by a processor of a portable electronic device, the computer process further comprising;
establishing communications between the portable electronic device and a second computer system according to a communications standard supported by the portable electronic device;
receiving information from the second computer system in dependence upon an aspect of the credit.

17. The one or more non-transitory tangible computer readable media according to claim 16 encoding a computer process for execution by a processor of a portable electronic device, wherein,
receiving information from the second computer system comprises at least one:
communicating a third electronic message from the portable electronic device to the second computer system to establish an association of the portable electronic device to the credit, the third electronic message generated in dependence upon the third data portion relating to a unique first user credential; and
identifying an aspect of the portable electronic device against information stored on at least one of the second computer system, the first computer system, and a third computer system in communication with the second computer system.
